(19) United States
(12) Patent Application Publication
(10) Pub. No.: US 2023/0183452 A1
(43) Pub. Date: Jun. 15, 2023

(54) Flame Retardant Thermoplastic Polymer Composition

(71) Applicant: Celanese International Corporation, Irving, TX (US)

(72) Inventors: Arno Wolf, Schonau (DE); Juergen Schmidt, Utzenfeld (DE); Guglielmo Pasetti, Lodi (IT)

(21) Appl. No.: 18/079,484

(22) Filed: Dec. 12, 2022

Related U.S. Application Data
(60) Provisional application No. 63/288,954, filed on Dec. 13, 2021.
(60) Provisional application No. 63/388,730, filed on Jul. 13, 2022.
(60) Provisional application No. 63/417,543, filed on Oct. 19, 2022.

(51) Int. Cl. C08K 5/5313; C08K 5/5333; H01M 50/121; C08L 77/10; C08K 3/40; C08K 7/14

(52) U.S. Cl. CPC C08K 5/5313; C08K 5/5333; H01M 50/121; C08L 77/10; C08K 3/40; C08K 7/14; H01M 2220/20

(57) ABSTRACT

A flame retardant thermoplastic polymer composition is disclosed. The flame retardant composition can include a flame retardant system comprised of only two flame retardant components. The composition can display excellent flame resistant properties at extremely small thicknesses. The composition can also contain a stabilizer package that dramatically improves heat aging properties.

### RELATED APPLICATIONS

The present application is based upon and claims priority to U.S. Provisional Patent Application Ser. No. 63/288,954, having a filing date of Dec. 13, 2021; U.S. Provisional Patent Application Ser. No. 63/388,730, having a filing date of Jul. 13, 2022; and U.S. Provisional Patent Application Ser. No. 63/417,543, having a filing date of Oct. 19, 2022, all of which are incorporated herein by reference.

### BACKGROUND

Various electrical components, such as connectors and housings, have recently grown in importance due to the advent of the electric vehicle and the continuous advancement in other electronic components. Electric vehicles including hybrid vehicles, for instance, generally have an electric powertrain that contains an electric propulsion source, such as thousands of lithium ion battery cells, and at least one electric motor. The electric propulsion source provides a high voltage electrical current that is supplied to the motor via one or more power electronics modules. Consequently, electric vehicles require the use of many electrical connectors that are used to convey the high voltage electrical current.

In addition to use in electric vehicles, similar electric connectors are needed in many industrial processes and systems and in household electrical systems and appliances.

In the past, electrically conductive elements contained in the connectors or in other electronic components were surrounded by an insulating polymer. Due to their small size and complex geometry, polyamide polymers including glass reinforced polyamide polymers have been commonly used to construct the electrical components.

Polyamide compositions, especially when reinforced with glass fibers, however, typically do not possess sufficient ignition or flame resistance as may be required by various governmental agencies. Consequently, in the past, polyamide polymers have been combined with one or more flame retardants.

For example, one common flame retardant package that has been used in the past includes the combination of an aluminum diethyl phosphinate (DEPAL) combined with a melamine compound, such as melamine cyanurate or melamine polyphosphate, and zinc borate. Such compositions, for instance, are disclosed in U.S. Pat. Nos. 6,255,371, 6,547,992, and U.S. Patent Publication No. 2006/0089435, which are all incorporated herein by reference. In the past, the presence of all three of the above components were typically necessary for polyamide compositions to exhibit a VO rating as determined in accordance with UL 94 at a thickness of 1.6 mm.

Other flame retardant packages for use in polyamide compositions are disclosed in U.S. Pat. Nos. 9,708,538 and 10,221,301, which are also incorporated herein by reference. The above references also mention the use of 9,10-dihydro-9-oxa-10-phosphaphenathrene-10-oxide (DOPO) and derivatives thereof.

Although the flame retardant packages described above have been successful when used in previous generations of products, further improvements are needed, especially as the popularity of the electric vehicle increases. In particular, a need exists for a polyamide composition capable of displaying excellent flame resistance at smaller thicknesses. A need also exists for a flame retardant package for incorporation into polyamide polymers that improves the ability to melt process and mold the polymer into various shapes and complex structures. In addition, a need further exists for a flame retardant polyamide polymer composition that also displays improved heat stability.

### SUMMARY

In general, the present disclosure is directed to a polyamide composition containing a flame retardant system that exhibits excellent flame resistance even at small thicknesses, has improved processing properties, and/or displays improved heat stability.

For example, in one embodiment, the present disclosure is directed to a flame retardant polymer composition comprising a polyamide polymer, a plurality of inorganic fibers, and a flame retardant system. The flame retardant system includes a metal phosphinate and a synergist. In accordance with the present disclosure, the synergist comprises a melamine metal phosphate or a melamine poly(metal phosphate). In one embodiment, the flame retardant system can be present in the polymer composition in an amount greater than about 18.5% by weight. The polymer composition can also be formulated to be free of zinc borate or other similar salts. The polymer composition can be formulated to exhibit a VO rating as determined in accordance with UL 94 at a thickness of only 0.4 mm. In addition, the polymer composition can be formulated to display a comparative tracking index of 600 volts or more as determined in accordance with IC 60112:2020.

In one embodiment, the metal phosphinate has the general formula (I) and/or formula (II):

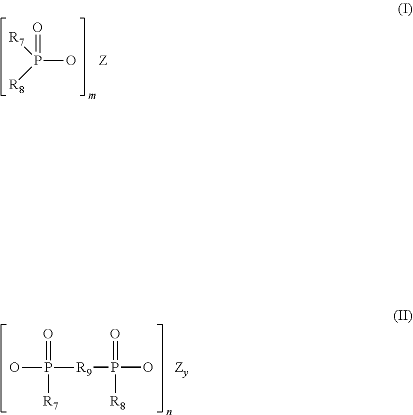

wherein, R₇ and R₈ are, independently, hydrogen or substituted or unsubstituted, straight chain, branched, or cyclic hydrocarbon groups having 1 to 6 carbon atoms; R₉ is a substituted or unsubstituted, straight chain, branched, or cyclic C₁-C₁₀ alkylene, arylene, arylalkylene, or alkylarylene group; Z is Mg, Ca, Al, Sb, Sn, Ge, Ti, Zn, Fe, Zr, Ce, Bi, Sr, Mn, Li, Na, K, and/or a protonated nitrogen base; y is from 1 to 4; n is from 1 to 4; and m is from 1 to 4. The metal phosphinate can be present in the polymer composition in an amount from about 10% by weight to about 20% by weight, such as from about 12.5% by weight to about 16% by weight. In one aspect, the synergist comprises melamine poly(zinc phosphate). The synergist can be present in the polymer composition in an amount from about 4% by weight to about 12% by weight, such as from about 6.5% by weight to about 9% by weight.

In addition to a flame retardant system, the polymer composition can contain a stabilizer package that can provide various advantages and benefits. The stabilizer package can comprise at least a heat stabilizer. The heat stabilizer can optionally be combined with an antioxidant and/or a light stabilizer. The heat stabilizer can comprise, for instance, a copper complex. A heat stabilizer well suited for use in the present disclosure includes iodobis(triphenylphosphino) copper as one or the only component. In general, any suitable antioxidant can be combined with a heat stabilizer. In one aspect, the antioxidant comprises a diphosphonite. In one embodiment, the antioxidant comprises a reaction product of 2,4-di-tert-butylphenol, phosphorous trichloride, and 1,1′-biphenyl. When present, the light stabilizer can comprise a hindered amine light stabilizer. For instance, the light stabilizer may comprise a benzendicarboxamide.

The stabilizer package incorporated into the polymer composition can dramatically improve the heat aging properties of the composition. For example, after being heat aged at 200° C. for 1,500 hours, the polymer composition can exhibit a drop in notched Charpy impact strength resistance of less than about 50%, such as less than about 40%. Similarly, the tensile strength can decrease no more than about 50%, such as by less than about 40%.

In one embodiment, the polymer composition can also contain metal oxide particles and/or a lubricant. The metal oxide particles, for instance, can comprise silicon dioxide particles. The metal oxide particles can be present in the polymer composition in an amount from about 0.01% by weight to about 1.5% by weight, such as from about 0.01% by weight to about 0.3% by weight. The lubricant can comprise a partially saponified ester wax. For example, the lubricant can comprise a partially saponified ester wax of a C22 to C36 fatty acid.

One or more polyamides are generally present in the polymer composition in an amount from about 30% to about 70% by weight. The one or more polyamides present in the polymer composition can be one or more aliphatic polyamides alone or in combination with a semi-aromatic polyamide or a wholly aromatic polyamide. Aliphatic polyamides that may be present in the polymer composition include nylon-6, nylon-6,6, copolymers thereof, or combinations thereof.

The inorganic fibers present in the polymer composition can comprise glass fibers. The glass fibers can be present in an amount from about 5% by weight to about 50% by weight, such as from about 25% by weight to about 35% by weight. In one embodiment, the glass fibers can have an average fiber length of from about 150 microns to about 600 microns.

All different types of polymer articles can be molded from the polymer composition of the present disclosure. The polymer composition is particularly well suited to being molded into a component of an electrical device. The electrical device, for instance, can include an electrically conductive component surrounded by a molded polymer component formed from the polymer composition of the present disclosure. The electrical device, for example, may comprise an electrical switch, an electrical contactor, a circuit breaker, a contact rail, a battery, a battery plug board, a switch gear, or a busbar. The molded polymer component can contact and directly surround the conductive component. Alternatively, the molded polymer component can comprise a housing that surrounds the conductive component.

In one embodiment, the electrical device can be an electrical connector that comprises opposing walls between which a passageway is defined for receiving a contact pin. At least one of the walls can be made from the flame retardant polymer composition as described above. In one particular embodiment, the electrical connector can comprise a high voltage powertrain or charging connector for an electric vehicle.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of a high voltage charging connector that may incorporate the polymer composition of the present disclosure;

FIG. 2 is a perspective view of a high voltage electrical connector that includes a polymer component made in accordance with the present disclosure;

FIG. 3 is a perspective view of a molded electrical housing made in accordance with the present disclosure, which may be used to enclose a lithium ion battery;

FIG. 4 is a perspective view of a battery plug board that may be made in accordance with the present disclosure;

FIG. 5 is a perspective view of a circuit breaker that may be made in accordance with the present disclosure;

FIG. 6 is a perspective view of a contact rail that includes a polymer component made in accordance with the present disclosure;

FIG. 7 is a perspective view of an electrical switch that may be made in accordance with the present disclosure;

FIG. 8 is a perspective view of another embodiment of a circuit breaker that may be made in accordance with the present disclosure;

FIG. 9 is a perspective view of an electrical connector that may be made in accordance with the present disclosure;

FIG. 10 is a graphical representation of the results obtained in the examples below;

FIG. 11 is a graphical representation of the results obtained in the examples below; and

FIG. 12 is a perspective assembly view of one embodiment of a power distribution box that may employ the polymer composition of the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present invention.

In general, the present disclosure is directed to a flame retardant polyamide polymer composition that contains at least one polyamide resin in combination with a flame retardant system and optionally reinforcing fibers. The flame retardant system can include a combination of a metal phosphinate and a synergist. The synergist can be, for instance, a melamine metal phosphate or a melamine poly(metal phosphate). Of particular advantage, the combination of the metal phosphinate and the synergist has been found to dramatically improve the flame resistant properties of the polymer composition at extremely small thicknesses without having to incorporate into the polyamide composition a metal salt, such as zinc borate. For example, the polymer composition of the present disclosure can be formulated so as to exhibit a VO rating as determined in accordance with UL 94 at a thickness of only 0.4 mm. In addition, it was discovered that not only does the flame retardant system of the present disclosure not interfere with the melt processing characteristics of the polymer composition, but actually has been found to produce a polyamide polymer composition with better melt flow properties and processing characteristics than many flame retardant compositions formulated in the past. This result was completely unexpected.

In one aspect, the polymer composition of the present disclosure can further contain a stabilizer package. The stabilizer package can include an antioxidant, a heat stabilizer, and optionally a light stabilizer. The stabilizer package in combination with the flame retardant system has been found to greatly improve the heat aging characteristics of the polyamide polymer composition in comparison to flame retardant formulations used in the past. For instance, even after being heat aged for 1,500 hours at 200° C., polymer compositions formulated in accordance with the present disclosure exhibit a reduction in notched Charpy impact resistance strength of less than 50%, such as less than about 45%, such as less than about 40%, such as even less than about 35%. In addition to impact resistance strength, the tensile strength of the polymer composition also displays excellent heat aging properties. For example, after being heat aged at 200° C. for 1,500 hours, the tensile strength of the polymer composition decreases by no more than about 50%, such as by no more than about 45%, such as by no more than about 40%, such as by no more than about 35%.

In addition to flame retardant properties and/or heat aging stability, the polymer composition of the present disclosure can also display excellent comparative tracking index properties. The comparative tracking index (CTI) is the maximum voltage, measured in volts, at which a material withstands 50 drops of contaminated water without tracking. Tracking is defined as the formation of conductive paths due to electrical stress, humidity, and contamination. The comparative tracking index test is an accelerated simulation to determine possible future failures that typically result in a short in electrical equipment using the polyamide polymer composition as an insulating material. Comparative tracking index can be measured according to Test IEC 60112:2020. The flame retardant polyamide polymer composition of the present disclosure can be formulated to display a comparative tracking index of 600 volts or more, such as 650 volts or more, such as 700 volts or more.

The flame retardant polyamide composition of the present disclosure also displays excellent physical and mechanical properties. For example, the polyamide composition can exhibit a Charpy notched impact strength of greater than about 7 kJ/m², such as greater than about 8 kJ/m², such as greater than about 8.2 kJ/m², such as greater than about 8.4 kJ/m², and generally less than about 30 kJ/m² when measured at 23° C. according to ISO Test No. 179/1:2010.

The polyamide composition can exhibit a tensile strength of generally greater than about 90 MPa, such as greater than about 95 MPa, such as greater than about 100 MPa, such as greater than about 105 MPa, such as greater than about 115 MPa, and generally less than about 200 MPA. Tensile properties can be determined in accordance with ISO Test No. 527:2012.

Due to the excellent flame resistance properties, excellent mechanical properties, and/or excellent thermal stability properties in combination with improved melt processing properties, the polymer composition of the present disclosure is well suited for making all different types of articles and components. The polymer composition is particularly well suited for producing all different types of electrical components. Such components can include high voltage powertrain connectors, and/or charging connectors for electric vehicles and other devices that may be powered using lithium ion batteries. The polymer composition is also well suited to producing electrical switches, electrical contactors, circuit breakers, contact rails, batteries, battery plug boards, switch gears, and the like. The polymer composition can serve as a housing for encasing the electrical component or can be an insulative component that directly surrounds an electrical contact pin or other conductive member.

In general, any suitable polyamide can be incorporated into the polymer composition. The polymer composition, for instance, can include a single polyamide polymer or can include a mixture of different polyamide polymers.

In general, one or more polyamide polymers are present in the polymer composition in an amount from about 20% by weight to about 85% by weight, including all increments of 1% by weight therebetween. For example, the polymer composition may contain one or more polyamides in an amount greater than about 30% by weight, such as in an amount greater than about 40% by weight, such as in an amount greater than about 50% by weight, and generally less than about 80% by weight, such as less than about 70% by weight, such as less than about 65% by weight, such as less than about 60% by weight.

Polyamides generally have a CO—NH linkage in the main chain and are obtained by condensation of a diamine and a dicarboxylic acid, by ring opening polymerization of lactam, or self-condensation of an amino carboxylic acid. For example, the polyamide may contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Of course, aromatic and/or alicyclic diamines may also be employed. Furthermore, examples of the dicarboxylic acid component may include aromatic dicarboxylic acids (e.g., terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc.), aliphatic dicarboxylic acids (e.g., adipic acid, sebacic acid, etc.), and so forth. Examples of lactams include pyrrolidone, aminocaproic acid, caprolactam, undecanlactam, lauryl lactam, and so forth. Likewise, examples of amino carboxylic acids include amino fatty acids, which are compounds of the aforementioned lactams that have been ring opened by water.

In certain embodiments, an “aliphatic” polyamide is employed that is formed only from aliphatic monomer units (e.g., diamine and dicarboxylic acid monomer units). Particular examples of such aliphatic polyamides include, for instance, nylon-4 (poly-α-pyrrolidone), nylon-6 (polycaproamide), nylon-11 (polyundecanamide), nylon-12 (polydodecanamide), nylon-46 (polytetramethylene adipamide), nylon-66 (polyhexamethylene adipamide), nylon-610, and nylon-612. Nylon-6 and nylon-66 are particularly suitable. In one particular embodiment, for example, nylon-6 or nylon-66 may be used alone. In other embodiments, blends of nylon-6 and nylon-66 may be employed. When such a blend is employed, the weight ratio of nylon-66 to nylon-6 is typically from 1 to about 2, in some embodiments from about 1.1 to about 1.8, and in some embodiments, from about 1.2 to about 1.6.

It is also possible to include aromatic monomer units in the polyamide such that it is considered semi-aromatic (contains both aliphatic and aromatic monomer units) or wholly aromatic (contains only aromatic monomer units). For instance, suitable semi-aromatic polyamides may include poly(nonamethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephthalamide/tetramethylene hexanediamide) (PA10T/46), poly(decamethylene terephthalamide/caprolactam) (PA10T16), poly(decamethylene terephthalamide/hexamethylene hexanediamide) (PA10T/66), poly(dodecamethylene terephthalamide/dodecamethylene dodecanediarnide) (PA12T/1212), poly(dodecamethylene terephthalamide/caprolactam) (PA12T/6), poly(dodecamethylene terephthalamide/hexamethylene hexanediamide) (PA12T/66), and so forth.

In one embodiment, the polymer composition contains primarily aliphatic polyamide polymers that may be blended with one or more semi-aromatic polyamide polymers or a wholly aromatic polyamide polymer.

The polyamide employed in the polyamide composition is typically crystalline or semi-crystalline in nature and thus has a measurable melting temperature. The melting temperature may be relatively high such that the composition can provide a substantial degree of heat resistance to a resulting part. For example, the polyamide may have a melting temperature of about 220° C. or more, in some embodiments from about 240° C. to about 325° C., and in some embodiments, from about 250° C. to about 335° C. The polyamide may also have a relatively high glass transition temperature, such as about 30° C. or more, in some embodiments about 40° C. or more, and in some embodiments, from about 45° C. to about 140° C. The glass transition and melting temperatures may be determined as is well known in the art using differential scanning calorimetry (“DSC”), such as determined by ISO Test No. 11357-2:2013 (glass transition) and 11357-3:2011 (melting).

In one embodiment, the polyamide polymer incorporated into the polymer composition can comprise a post-industrial recycled polymer. For instance, the recycled polyamide polymer can be obtained from industrial fiber including tire cord, from carpet fiber, from textile fiber, from films, from fabrics including airbag fabrics, and the like. When incorporated into the polymer composition, the recycled polyamide polymers are optionally combined with virgin polymers. For example, the weight ratio between recycled polyamide polymers and virgin polyamide polymers can be from about 1:10 to about 10:1. For example, the amount of recycled polyamide polymer incorporated into the polymer composition can be greater than about 8% by weight, such as greater than about 10% by weight, such as greater than about 12% by weight, such as greater than about 15% by weight, such as greater than about 18% by weight, such as greater than about 20% by weight, such as greater than about 22% by weight, such as greater than about 30% by weight, such as greater than about 40% by weight, such as greater than about 50% by weight, such as greater than about 70% by weight, such as greater than about 80% by weight, such as greater than about 90% by weight, such as up to 100% by weight. The recycled polyamide is generally present in an amount less than about 90% by weight, such as in an amount less than about 70% by weight, such as in an amount less than about 50% by weight, such as in an amount less than about 45% by weight, such as less than about 35% by weight, such as less than about 30% by weight, based on the total amount of polyamide polymers present.

In addition to one or more polyamide polymers, the flame retardant polymer composition of the present disclosure may optionally contain reinforcing fibers, which can be inorganic fibers. For example, the reinforcing fibers or inorganic fibers can be present in the polymer composition generally in an amount greater than about 5% by weight, such as in an amount greater than about 10% by weight, such as in an amount greater than about 15% by weight, such as in an amount greater than about 20% by weight, such as in an amount greater than about 25% by weight. The reinforcing fibers or inorganic fibers can be present in the polymer composition generally in an amount less than about 50% by weight, such as in an amount less than about 45% by weight, such as in an amount less than about 40% by weight, such as in an amount less than about 35% by weight.

The inorganic fibers generally have a high degree of tensile strength relative to their mass. For example, the ultimate tensile strength of the fibers is typically from about 1,000 to about 15,000 MPa, in some embodiments from about 2,000 MPa to about 10,000 MPa, and in some embodiments, from about 3,000 MPa to about 6,000 MPa. The high strength fibers may be formed from materials that are also electrically insulative in nature, such as glass, ceramics (e.g., alumina or silica), etc., as well as mixtures thereof. Glass fibers are particularly suitable, such as E-glass, A-glass, C-glass, D-glass, AR-glass, R-glass, S1-glass, S2-glass, etc., and mixtures thereof. The inorganic fibers may have a relatively small median diameter, such as about 50 micrometers or less, in some embodiments from about 0.1 to about 40 micrometers, and in some embodiments, from about 2 to about 20 micrometers, such as determined using laser diffraction techniques in accordance with ISO 13320:2009 (e.g., with a Horiba LA-960 particle size distribution analyzer). It is believed that the small diameter of such fibers can allow their length to be more readily reduced during melt blending, which can further improve surface appearance and mechanical properties. After formation of the polymer composition, for example, the average length of the inorganic fibers may be relatively small, such as from about 10 to about 800 micrometers, in some embodiments from about 100 to about 700 micrometers, and in some embodiments, from about 150 to about 600 micrometers. The inorganic fibers may also have a relatively high aspect ratio (average length divided by nominal diameter), such as from about 1 to about 100, in some embodiments from about 10 to about 60, and in some embodiments, from about 30 to about 50.

In accordance with the present disclosure, the polyamide polymer composition of the present disclosure also contains a flame retardant system. In one aspect, the flame retardant system of the present disclosure only contains two flame retardant components, although in other embodiments various other components may be added. Excellent flame resistant properties in combination with excellent melt processing characteristics can be obtained by only incorporating into the polymer composition a non-halogen flame retardant in combination with a synergist. Constructing the flame retardant system from only two components is believed to provide numerous benefits regarding various efficiencies in formulating the composition in combination with excellent overall properties.

In one embodiment, the flame retardant system of the present disclosure contains a metal phosphinate in combination with a synergist. The synergist can comprise an azine metal phosphate or an azine poly(metal phosphate).

The amount of flame retardant system incorporated into the polymer composition can vary depending upon the particular application and the desired result. In general, the flame retardant system is present in the polymer composition in an amount greater than about 16% by weight, such as in an amount greater than about 18% by weight. In one embodiment, the amount of flame retardant system incorporated into the polymer composition can be relatively high without any adverse impacts on the mechanical properties of the composition or on the ability to melt process the composition. For example, the flame retardant system can be incorporated into the polymer composition in an amount greater than about 18.5% by weight, such as in an amount greater than about 19% by weight, such as in an amount greater than about 19.5% by weight, such as in an amount greater than about 20% by weight, such as in an amount greater than about 20.5% by weight, such as in an amount greater than about 21% by weight, such as in an amount greater than about 21.5% by weight, such as in an amount greater than about 22% by weight. The flame retardant system is generally present in the composition in an amount less than about 28% by weight, such as in an amount less than about 25% by weight, such as in an amount less than about 24% by weight.

As described above, the flame retardant system can include a phosphinate flame retardant, such as a metal phosphinate. Such phosphinates are typically salts of a phosphinic acid and/or diphosphinic acid, such as those having the general formula (I) and/or formula (II):

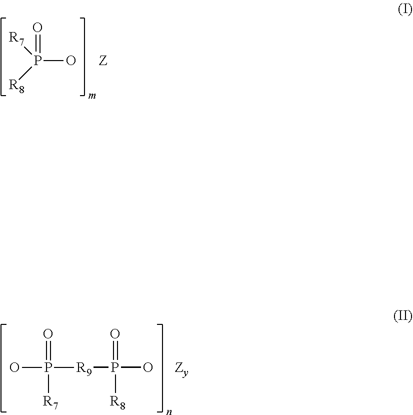

wherein,
R₇ and R₈ are, independently, hydrogen or substituted or unsubstituted, straight chain, branched, or cyclic hydrocarbon groups (e.g., alkyl, alkenyl, alkynyl, aralkyl, aryl, alkaryl, etc.) having 1 to 6 carbon atoms, particularly alkyl groups having 1 to 4 carbon atoms, such as methyl, ethyl, n-propyl, iso-propyl, n-butyl, or tert-butyl groups;
R₉ is a substituted or unsubstituted, straight chain, branched, or cyclic C₁-C₁₀ alkylene, arylene, arylalkylene, or alkylarylene group, such as a methylene, ethylene, n-propylene, iso-propylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, t-butylnaphthylene, phenylethylene, phenylpropylene or phenylbutylene group;
Z is Mg, Ca, Al, Sb, Sn, Ge, Ti, Zn, Fe, Zr, Ce, Bi, Sr, Mn, Li, Na, K, and/or a protonated nitrogen base;
y is from 1 to 4, and preferably 1 to 2 (e.g., 1);
n is from 1 to 4, and preferably 1 to 2 (e.g. 1); and
m is from 1 to 4 and preferably 1 to 2 (e.g., 2).

The phosphinates may be prepared using any known technique, such as by reacting a phosphinic acid with a metal carbonate, metal hydroxide, or metal oxides in aqueous solution. Particularly suitable phosphinates include, for example, metal salts of dimethylphosphinic acid, ethylmethylphosphinic acid, diethylphosphinic acid, methyl-n-propylphosphinic acid, methane-di(methylphosphinic acid), ethane-1,2-di(methylphosphinic acid), hexane-1,6-di(methylphosphinic acid), benzene-1,4-di(methylphosphinic acid), methylphenylphosphinic acid, diphenylphosphinic acid, hypophosphoric acid, etc. The resulting salts are typically monomeric compounds; however, polymeric phosphinates may also be formed. Particularly suitable metals for the salts may include Al and Zn. For instance, one particularly suitable phosphinate is zinc diethylphosphinate. Another particularly suitable phosphinate is aluminum diethylphosphinate.

One or more metal phosphinates can generally be present in the polymer composition in an amount greater than about 8% by weight, such as in an amount greater than about 10.5% by weight, such as in an amount greater than about 12.5% by weight, such as in an amount greater than about 13% by weight, such as in an amount greater than about 13.5% by weight, such as in an amount greater than about 14% by weight. One or more metal phosphinates are generally present in the polymer composition in an amount less than about 20% by weight, such as in an amount less than about 18% by weight, such as in an amount less than about 16.5% by weight.

In accordance with the present disclosure, the metal phosphinate is combined with a synergist. The synergist can comprise an azine metal phosphate or an azine poly(metal phosphate). In one aspect, the synergist can comprise a triazine-intercalated metal phosphate or poly(metal phosphate). The synergist, for instance, can be formed by the reaction of an acidic metal phosphate with melamine. Examples of synergists that are particularly well suited for use in the present disclosure include melamine zinc phosphate, melamine poly(zinc phosphate), melamine magnesium phosphate, melamine poly(magnesium phosphate), melamine calcium phosphate, melamine poly(calcium phosphate) or mixtures thereof.

In one aspect, the synergist can be (melamine)₂Mg(HPO₄)₂, (melamine)₂Ca(HPO₄)₂, (melamine)₂Zn(HPO₄)₂, (melamine)₃Al(HPO₄)₃, (melamine)₂Mg(P₂O₇), (melamine)₂Ca(P₂O₇), (melamine)₂Zn(P₂O₇), (melamine)₃Al(P₂O₇)_{3/2}.

In one aspect, the synergist can be melamine poly(metal phosphates) that are known as hydrogenphosphato- or pyrophosphatometalates with complex anions having a tetra- or hexavalent metal atom as coordination site with bidentate hydrogenphosphate or pyrophosphate ligands.

In one aspect, the synergist can be melamine-intercalated aluminum, zinc or magnesium salts of condensed phosphates, very particular preference to bismelamine zincodiphosphate and/or bismelamine aluminotriphosphate.

In one aspect, the synergist can be aluminum phosphates, aluminum monophosphates, aluminum orthophosphates (AIPO.sub.4), aluminum hydrogenphosphate (Al₂(HPO₄)₃) and/or aluminum dihydrogenphosphate.

In one aspect, the synergist can be calcium phosphate, zinc phosphate, titanium phosphate and/or iron phosphate.

In one aspect, the synergist can be calcium hydrogenphosphate, calcium hydrogenphosphate dihydrate, magnesium hydrogenphosphate, titanium hydrogenphosphate (TIHC) and/or zinc hydrogenphosphate.

In one aspect, the synergist can be aluminum dihydrogenphosphate, magnesium dihydrogenphosphate, calcium dihydrogenphosphate, zinc dihydrogenphosphate, zinc dihydrogenphosphate dihydrate and/or aluminum dihydrogenphosphate.

In one aspect, the synergist can be calcium pyrophosphate, calcium dihydrogenpyrophosphate, magnesium pyrophosphate, zinc pyrophosphate and/or aluminum pyrophosphate.

The synergist can generally be present in the polymer composition in an amount greater than about 4% by weight, such as in an amount greater than about 5% by weight, such as in an amount greater than about 6.5% by weight, such as in an amount greater than about 7% by weight, and generally less than about 12% by weight, such as in an amount less than about 9% by weight, such as in an amount less than about 8.5% by weight.

As described above, in one embodiment, the flame retardant system can be comprised of only the two components described above. It was discovered that excellent flame retardancy characteristics can be obtained without having to add other components that were conventionally used in the past. For instance, the polymer composition can be formulated so as to be free of metal oxides, metal hydroxides, borates, silicates, stannates, or the like that have been used in the past to increase flame retardant properties. For example, the polymer composition can be free of magnesium oxide, zinc oxide, manganese oxide, tin oxide, dihydrotalcite, hydrocalumite, magnesium hydroxide, calcium hydroxide, zinc hydroxide, tin oxide hydrate, manganese hydroxide, zinc borate, basic zinc silicate, zinc stannate, and the like.

The polymer composition can contain very small amounts of halogens and can be free of halogen-based flame retardants. For example, halogen content (i.e., bromine, fluorine, and/or chlorine) can be about 15,000 parts per million (“ppm”) or less, in some embodiments about 10,000 ppm or less, in some embodiments about 5,000 ppm or less, in some embodiments about 200 ppm or less, and in some embodiments, from about 1 ppm to about 1,500 ppm. Nevertheless, in certain embodiments of the present invention, halogen-based flame retardants may still be employed as an optional component. Particularly suitable halogen-based flame retardants are fluoropolymers, such as polytetrafluoroethylene (PTFE), fluorinated ethylene polypropylene (FEP) copolymers, perfluoroalkoxy (PFA) resins, polychlorotrifluoroethylene (PCTFE) copolymers, ethylene-chlorotrifluoroethylene (ECTFE) copolymers, ethylene-tetrafluoroethylene (ETFE) copolymers, polyvinylidene fluoride (PVDF), polyvinylfluoride (PVF), and copolymers and blends and other combination thereof. When employed, such halogen-based flame retardants typically constitute only about 10 wt. % or less, in some embodiments about 5 wt. % or less, and in some embodiments, about 1 wt. % or less of the flame retardant system. Likewise, the halogen-based flame retardants typically constitute about 5 wt. % or less, in some embodiments about 1 wt. % or less, and in some embodiments, about 0.5 wt. % or less of the entire polymer composition.

In one aspect, conventional nitrogen synergists can also be excluded from the composition. For example, the composition can be free of melamine polyphosphate and/or melamine cyanurate.

In one aspect, the polymer composition can further contain a stabilizer package. The stabilizer package has been found to dramatically improve the thermal aging stability of the composition. The stabilizer package can include a heat stabilizer alone or in combination with an antioxidant and/or a light stabilizer.

The heat stabilizer contained in the stabilizer package can comprise a copper complex. It is believed that the combination of the copper complex alone or in combination with the antioxidant greatly increase the thermal stability characteristics of the composition.

In one embodiment, for instance, the heat stabilizer can comprise iodobis(triphenylphosphino) copper.

In general, the heat stabilizer can include a copper compound that can include a copper(I) salt, copper(II) salt, copper complex, or a combination thereof. For example, the copper(I) salt may be Cul, CuBr, CuCl, CuCN, CU₂O, or a combination thereof and/or the copper(II) salt may be copper acetate, copper stearate, copper sulfate, copper propionate, copper butyrate, copper lactate, copper benzoate, copper nitrate, CuO, CuCl₂, or a combination thereof. In certain embodiments, the copper compound may be a copper complex that contains an organic ligand, such as alkyl phosphines, such as trialkylphosphines (e.g., tris-(n-butyl)phosphine) and/or dialkylphosphines (e.g., 2-bis-(dimethylphosphino)-ethane); aromatic phosphines, such as triarylphosphines (e.g., triphenylphosphine or substituted triphenylphosphine) and/or diarylphosphines (e.g., 1,6-(bis-(diphenylphosphino))-hexane, 1,5-bis-(diphenylphosphino)-pentane, bis-(diphenylphosphino)methane, 1,2-bis-(diphenylphosphino)ethane, 1,3-bis-(diphenylphosphino)propane, 1,4-bis-(diphenylphosphino)butane, etc.); mercaptobenzimidazoles; glycines; oxalates; pyridines (e.g., bypyridines); amines (e.g., ethylenediaminetetraacetates, diethylenetriamines, triethylenetetramines, etc.); acetylacetonates; and so forth, as well as combinations of the foregoing. Particularly suitable copper complexes for use in the heat stabilizer may include, for instance, copper acetylacetonate, copper oxalate, copper EDTA, [Cu(PPh₃)₃X], [Cu₂X(PPH₃)₃], [Cu(PPh₃)X], [Cu(PPh₃)₂X], [CuX(PPh₃)-2,2′-bypyridine], [CuX(PPh₃)-2,2′-biquinoline)], or a combination thereof, wherein PPh₃ is triphenylphosphine and X is Cl, Br, I, CN, SCN, or 2-mercaptobenzimidazole. Other suitable complexes may likewise include 1,10-phenanthroline, o-phenylenebis(dimethylarsine), 1,2-bis(diphenylphosphino)-ethane, terpyridyl, and so forth.

When employed, the copper complexes may be formed by reaction of copper ions (e.g., copper(I) ions) with the organic ligand compound (e.g., triphenylphosphine or mercaptobenzimidazole compounds). For example, these complexes can be obtained by reacting triphenylphosphine with a copper(I) halide suspended in chloroform (G. Kosta, E. Reisenhofer and L. Stafani, J. Inorg. Nukl. Chem. 27 (1965) 2581). However, it is also possible to reductively react copper(II) compounds with triphenylphosphine to obtain the copper(I) addition compounds (F. U. Jardine, L. Rule, A. G. Vohrei, J. Chem. Soc. (A) 238-241 (1970)). However, the complexes used according to the invention can also be produced by any other suitable process. Suitable copper compounds for the preparation of these complexes are the copper(I) or copper(II) salts of the hydrogen halide acids, the hydrocyanic acid or the copper salts of the aliphatic carboxylic acids. Examples of suitable copper salts are copper (I) chloride, copper (I) bromide, copper (I) iodide, copper (I) cyanide, copper (II) chloride, copper (II) acetate, copper (II) stearate, etc., as well as combinations thereof. Copper(I)iodide and copper(I)cyanide are particularly suitable.

In addition to a copper compound, the heat stabilizer may also contain a halogen-containing synergist. When employed, the copper compound and halogen-containing synergist are typically used in quantities to provide a copper:halogen molar ratio of from about 1:1 to about 1:50, in some embodiments from about 1:4 to about 1:20, and in some embodiments, from about 1:6 to about 1:15. For example, the halogen content of the polymer composition may be from about 1 ppm to about 10,000 ppm, in some embodiments from about 50 ppm to about 5,000 ppm, in some embodiments from about 100 ppm to about 2,000 ppm, and in some embodiments, from about 300 ppm to about 1,500 ppm. In one aspect, the halogen content of the polymer composition is less than about 1000 ppm, such as less than about 600 ppm, such as less than about 500 ppm, such as less than about 400 ppm.

The halogenated synergist generally includes an organic halogen-containing compound, such as aromatic and/or aliphatic halogen-containing phosphates, aromatic and/or aliphatic halogen-containing hydrocarbons; and so forth, as well as combinations thereof. For example, suitable halogen-containing aliphatic phosphates may include tris(halohydrocarbyl)-phosphates and/or phosphonate esters. Tris(bromohydrocarbyl) phosphates (brominated aliphatic phosphates) are particularly suitable. In particular, in these compounds, no hydrogen atoms are attached to an alkyl C atom which is in the alpha position to a C atom attached to a halogen. This minimizes the extent that a dehydrohalogenation reaction can occur which further enhances stability of the polymer composition. Specific exemplary compounds are tris(3-bromo-2,2-bis(bromomethyl)propyl)phosphate, tris(dibromoneopentyl)phosphate, tris(trichloroneopentyl)phosphate, tris(bromodichlorneopentyl)phosphate, tris(chlordibromoneopentyl)phosphate, tris(tribromoneopentyl)phosphate, or a combination thereof. Suitable halogen-containing aromatic hydrocarbons may include halogenated aromatic polymers (including oligomers), such as brominated styrene polymers (e.g., polydibromostyrene, polytribromostyrene, etc.); halogenated aromatic monomers, such as brominated phenols (e.g., tetrabromobisphenol-A); and so forth, as well as combinations thereof.

The heat stabilizer can be present in the polymer composition generally in an amount greater than about 0.08% by weight, such as in an amount greater than about 0.1% by weight, such as in an amount greater than about 0.2% by weight, such as in an amount greater than about 0.3% by weight, such as in an amount greater than about 0.4% by weight, and generally in an amount less than about 2.5% by weight, such as in an amount less than about 2% by weight, such as in an amount less than about 1.5% by weight, such as in an amount less than about 1% by weight, such as in an amount less than about 0.8% by weight. In one aspect, The resulting copper content of the polymer composition can be from about 1 ppm to about 1,000 ppm, in some embodiments from about 3 ppm to about 200 ppm, in some embodiments from about 5 ppm to about 150 ppm, and in some embodiments, from about 20 ppm to about 120 ppm.

The antioxidant optionally present with the heat stabilizer can be a phenolic antioxidant. In one embodiment, for instance, the composition can contain a phenolic antioxidant. Examples of such phenolic antioxidants include, for instance, calcium bis(ethyl 3,5-di-tert-butyl-4-hydroxybenzylphosphonate) (Irganox® 1425); terephthalic add, 1,4-dithio-,S,S-bis(4-tert-butyl-3-hydroxy-2,6-dimethylbenzyl) ester (Cyanox® 1729); triethylene glycol bis(3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl)hydrazide (Irganox® 1024); 4,4′-di-tert-octyldiphenamine (Naugalube® 438R); phosphonic acid, (3,5-di-tert-butyl-4-hydroxybenzyl)-,dioctadecyl ester (Irganox® 1093); 1,3,5-trimethyl-2,4,6-tris(3′,5′-di-tert-butyl-4′ hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox® 1135); octadecyl 3-(3,5-di-tert-butyl-4-hydroxyphenyl)propionate (Irganox® 1076); 3,7-bis(1,1; 3,3 tetramethylbutyl)-10H-phenothiazine (Irganox® LO 3); 2,2′-methylenebis(4-methyl-6-tert-butylphenol)monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer® GS); 1,3-dihydro-2H-Benzimidazole (Sumilizer® MB); 2-methyl-4,6-bis[(octylthio)methyl]phenol (Irganox® 1520); N,N′-trimethylenebis-[3-(3,5-di-tert-butyl-4-hydroxyphenyl)propionamide (Irganox® 1019); 4-n-octadecyloxy-2,6-diphenylphenol (Irganox® 1063); 2,2′-ethylidenebis[4,6-di-tert-butylphenol] (Irganox® 129); N N′-hexamethylenebis(3,5-di-tert-butyl-4-hydroxyhydrocinnamamide) (Irganox® 1098); diethyl (3,5-di-tert-butyl-4-hydroxybenxyl)phosphonate (Irganox® 1222); 4,4″-di-tert-octyldiphenylamine (Irganox® 5057); N-phenyl-t-napthalenamine (Irganox® L 05); tris[2-tert-butyl-4-(3-ter-butyl-4-hydroxy-6-methylphenylthio)-5-methyl phenyl]phosphite (Hostanox® OSP 1); zinc dinonyidithiocarbamate (Hostanox® VP-ZNCS 1); 3,9-bis[1,1-diimethyl-2-[(3-tert-butyl-4-hydroxy-5-methylphenyl)propionyloxy]ethyl]-2,4,8,10-tetraoxaspiro[5.5]undecane (Sumilizer® AG80); pentaerythrityl tetrakis[3-(3,5-di-tert-butyl-4-hydroxyphenyl)propionate] (Irganox® 1010); ethylene-bis(oxyethylene)bis[3-(5-tert-butyl-4-hydroxy-m-tolyl)-propionate (Irganox® 245); 3,5-di-tert-butyl-4-hydroxytoluene (Lowinox BHT, Chemtura) and the like.

The stabilizer system may also include a phosphorous-containing antioxidant. When employed, such antioxidants typically constitute from about 2 wt. % to 50 wt. %, in some embodiments from about 5 wt. % to about 45 wt. %, and in some embodiments, from about 15 wt. % to about 35 wt. % of the stabilizer system. When employed, the weight ratio of the heat stabilizer(s) to the phosphorous-containing antioxidant(s) may be selectively controlled to achieve the desired properties, such as within a range of from about 1 to about 5, in some embodiments from about 1.1 to about 4, and in some embodiments, from about 1.5 to about 3.

The phosphorous-containing antioxidant may include, for instance, a phosphonite having the structure:

[R—P(OR₁)₂]ₘ (1)

wherein,
R is a mono- or polyvalent aliphatic, aromatic, or heteroaromatic organic radical, such as a cyclohexyl, phenyl, phenylene, and/or biphenyl radical; and
R₁ is independently a compound of the structure (II)

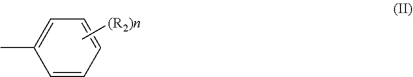

or the two radicals R₁ form a bridging group of the structure (III)

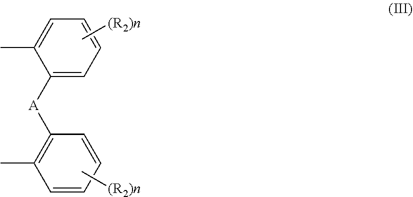

where
A is a direct bond, O, S, C₁₋₁₈ alkylene (linear or branched), or C₁₋₁₈ alkylidene (linear or branched); R₂ is independently C₁₋₁₂ alkyl (linear or branched), C₁₋₁₂ alkoxy, or C₅₋₁₂ cycloalkyl;
n is from 0 to 5, in some embodiments from 1 to 4, and in some embodiments, from 2 to 3, and
m is from 1 to 4, in some embodiments from 1 to 3, and in some embodiments, from 1 to 2 (e.g., 2).

Particular preference is given to compounds which, on the basis of the preceding claims, are prepared via a Friedel-Crafts reaction of an aromatic or heteroaromatic system, such as benzene, biphenyl, or diphenyl ether, with phosphorus trihalides, preferably phosphorus trichloride, in the presence of a Friedel-Crafts catalyst, such as aluminum chloride, zinc chloride, iron chloride, etc., and a subsequent reaction with the phenols underlying the structures (II) and (III). Mixtures with phosphites produced in the specified reaction sequence from excess phosphorus trihalide and from the phenols described above are expressly also covered by the invention.

In one particular embodiment, R₁ is a group of the structure (II). Among this group of compounds, antioxidants of the general structure (V) are particularly suitable:

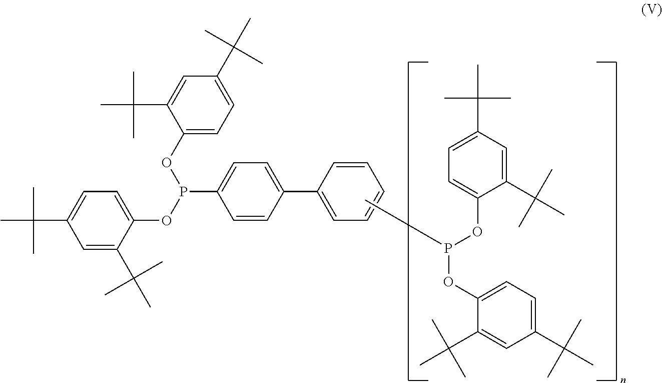

wherein, n is as defined above.

In one particular embodiment, for instance, n in formula (V) is 1 such that the antioxidant is tetrakis(2,4-di-tert-butylphenyl)4,4′-biphenylene-diphosphonite.

In one embodiment, the antioxidant can be a reaction product of 2,4-di-tert-butylphenol, phosphorous trichloride, and 1,1′-biphenyl.

One or more antioxidants can be present in the polymer composition generally in an amount greater than about 0.05% by weight, such as in an amount greater than about 0.08% by weight, such as in an amount greater than about 0.1% by weight, such as in an amount greater than about 0.15% by weight, such as in an amount greater than about 0.18% by weight, and generally less than about 2% by weight, such as less than about 1.5% by weight, such as less than about 1% by weight, such as less than about 0.8% by weight, such as less than about 0.5% by weight, such as less than about 0.4% by weight.

As described above, the stabilizer package can optionally include a light stabilizer which may comprise a hindered amine light stabilizer. Examples of light stabilizers that may be incorporated into the present disclosure include a benzendicarboxamide. The light stabilizer may also comprise any compound which is derived from an alkylsubtituted piperidyl, piperidinyl or piperazinone compound or a substituted alkoxypiperidinyl. Other suitable HALS are those that are derivatives of 2,2, 6,6-tetramethyl piperidine. Preferred specific examples of HALS include: ˜2,2, 6,6-tetramethyl-4-piperidinone, ˜2,2, 6,6-tetramethyl-4-piperidinol, ˜bis-(2, 2, 6,6-tetramethyl-4-piperidinyl)-sebacate, ˜mixtures of esters of 2,2,6,6-tetramethyl-4-piperidinol and fatty acids, ˜bis-(2,2,6,6-tetramethyl-4-piperidinyl)-succinate, ˜bis-(1-octyloxy-2,2,6,6-tetramethyl-4-piperidinyl)-sebacate, ˜bis-(1,2,2,6,6-pentamethyl-4-piperidinyl)-sebacate, ˜tetrakis-(2,2,6,6-tetramethyl-4-piperidyl)-1,2,3,4-butane-tetracarboxylate, ˜N-butyl-2,2,6,6-tetramethyl-4-piperidinamine, ˜N,N′-bis-(2,2,6,6-tetramethyl-4-piperidyl)-hexane-1,6-diamine, ˜2.2′-[(2.2.6.6-tetramethyl-4-piperidinyl)-imino]-bis-[ethanol], ˜5-(2.2.6.6-tetramethyl-4-piperidinyl)-2-cyclo-undecyl-oxazole), ˜mixture of: 2,2,4,4 tetramethyl-21-oxo-7-oxa-3.20-diazadispiro[5.1.11.2] heneicosane-20-propionic acid dodecylester and 2.2.4.4 tetramethyl-21-oxo-7; oxa-3,20-diazadispiro[5,1,11,2]-heneicosane-20-propionic acid; tetradecyl ester, ˜diacetam 5 (CAS registration number: 76505-58-3), ˜propanedioic acid, [(4-methoxyphenyl) methylene]-, bis(1,2,2,6,6-pentamethyl-4-piperidinyl) ester, ˜1,3-benzendicarboxamide, N,N′-bis (2,2,6,6-tetramethyl-4-piperidinyl), ˜3-dodecyl (2,2,6,6-tetramethyl-4-piperidyl)-pyrrolidin-2,5-dione, ˜formamide, N,N′-1,6-hexanediylbis[N-(2,2,6,6-tetramethyl-4-piperidinyl, ˜3-dodecyl-1-(1,2,2, 6,6-pentamethyl-4-piperidyl)-pyrrolidin-2,5-dione, ˜1,5-Dioxaspiro (5,5) undecane 3,3-dicarboxylic acid, bis (2,2,6,6-tetramethyl-4-peridinyl) ester, ˜1,5-Dioxaspiro (5,5) undecane 3,3-dicarboxylic acid, bis (1,2,2,6,6-pentamethyl-4-peridinyl) ester, ˜bis (1,2,2,6,6-penta methyl-4-piperidyl)(3,5-di-t-butyl-4-hydroxybenzyl)-butylpropanedioate, ˜tetrakis-(1,2,2,6,6-penta-methyl-4-piperidyl)-1,2,3,4-butane-tetra--carboxylate, ˜1,2,3,4-butanetetracarboxylic acid, tetrakis(2,2,6,6-tetramethyl-4-piperidinyl) ester, ˜1,2,3,4-butane-tetracarboxylic acid-1,2,3-tris (1,2,2,6,6-pentamethyl-4-piperidinyl)-4-tridecylester, ˜8-acetyl-3-dodecyl-7,7,9,9-tetra methyl-1,3,8-triazaspiro (4,5) decane-2,4-dione, ˜N-2,2,6,6-tetrametyl-4-piperidinyl-N-amino-oxamide, ˜4-acryloyloxy-1,2,2,6,6-pentamethyl-4-piperidine, ˜1,5,8,12˜tetrakis [2′,4′˜bis (1″,2″,2″,6″,6″-pentamethyl-4″-piperidinyl(butyl)amino)-1′,3′,5′-tr-iazin-6′-yl]-1,5,8,12-tetraazadodecane, ˜1,1′-(1,2-ethane-di-yl)-bis-(3,3′, 5,5′-tetra-methyl-piperazinone) (Good rite 3034), ˜propane amide, 2-methyl-N-(2,2,6,6-tetramethyl-4-piperidinyl)-2-[(2,2,6,6-tetramethyl-4-piperidinyl)amino], ˜oligomer of N-(2-hydroxyethyl)-2,2,6,6-tetramethyl-4-piperidinol and succinic acid, ˜poly [[6-[(1,1,3,3-tetramethylbutyl)amino]-s-triazine-2,4-diyl][2,2,6,6-tetram-ethyl-4-piperidinyl)imino] hexamethylene [(2,2,6,6-tetramethyl-4-piperidinyl)imino]], ˜poly [(6-morfoline-S-triazine-2.4-diyl) [(2.2.6.6-tetramethyl-4-piperidinyl)-imino]hexamethylene-[(2.2.6.6-tetram-ethyl-4-piperidinyl)-imino]], ˜poly [(6-morpholino-s-triazine-2.4-diyl) [1.2.2.6.6-penta-methyl-4-piperidyl) imino]-hexamethylene [(2,2,6,6 tetra-methyl-4-piperidyl) imino]], ˜poly methylpropyl-3-oxy-[4(2.2.6.6-tetrametyl)-piperidinyl)]siloxane copolymer of a-methylstyrene and n-(2.2.6.6-tetramethyl-piperidinyl)-4-maleimide and N-stearyl-maleimide, ˜1,2,3,4-butane tetracarboxylic acid, polymer with 8,8,8′,8′-tetramethyl-2,4,8,10-tetraoxaspiro [5,5] undecane-3,9-diethanol, 1,2,2, 6,6-pentamethyl-4-piperidinyl ester, ˜1,2, 3,4-butanetetracarboxylic acid, polymer with 8,8,8′,8′-tetramethyl-2,4,8,10-tetraoxaspiro [5,5] undecane-3,9-diethanol, 2,2,6,6-tetramethyl-4-piperidinyl ester, ˜oligomer of 7-Oxa-3,20-diazadispiro [5,1,11,2] heneicosan-21-one, 2,2,4,4-tetramethyl-20-(oxiranylmethyl), ˜1,3,5-Triazine-2,4,6-triamine, N, N″-[1,2-ethanediylbis [[[4,6˜bis[butyl(1,2,2,6,6-pentamethyl-4-iperidinyl)amino]-1,3,5-triazine--2-yl]imino]˜3,1-propanediyl]]˜bis [N. N″-dibutyl-N. N″˜bis (1.2.2.6.6-pentamethyl-4-piperidinyl), ˜1.3-Propanediamine, N, N-1,2-ethanediylbis-, polymer with 2,4,6-trichloro-1,3,5-triazine, reaction products with N-butyl-2,2,6,6-tetramethyl-4-piperidinamine, ˜1.6-Hexanediamine, N,N′˜bis (2,2,6,6-tetramethyl-4piperidinyl)-polymer with 2,4,6-trichloro-1,3,5-triazine, reaction products with N-butyl-1-butanamine and N-butyl-2,2,6,6-tetramethyl-4-piperidinamine, ˜2,9,11,13,15,22,24,26,27,28-Decaazatricyclo[21,3,1,110,14]octacosa-1(27), 10,12,14(28),23,25-hexaene-12, 25-diamine, N,N′˜bis (1,1,3,3-tetramethylbutyl)-2,9,15,22˜tetrakis (2,2,6,6-tetramethyl-4-piperidinyl)-, ˜1,1,1″-(1,3,5-Triazine-2,4,6-triyltris ((cyclohexylimino)-2,1-ethanediyl) tris (3,3,5,5-tetramethylpiperazinone), ˜1,1,1″-(1,3,5-Triazine-2,4,6-triyltris((cyclohexylimino)-2,1-ethylenediyl) tris (3,3,4,5,5-tetramethylpiperazinone), ˜1,6-hexanediamine, N, N′˜bis (2,2,6,6-tetramethyl-4-piperidinyl)-, polymer with 2,4,6-trichloro-1,3,5-triazine, reaction products with 3-bromo-1-propene, nbutyl-1-butanamine and N-butyl-2,2,6,6-tetramethyl-4-piperidinamine, oxidised, hydrogenated, ˜Alkenes, (C20-24)-4 alpha-, polymers with maleic anhydride, reaction products with 2,2,6,6-tetramethyl-4-piperidinamine, ˜N-2,2,6,6-tetramethyl-4-piperidinyl-N-amino-oxamide; 4-acryloyloxy-1,2,2,6,6-pentamethyl-4-piperidine, HALS PB-41 or mixtures thereof.

In one particular embodiment, the hindered amine light stabilizer includes an alkyl-substituted piperidyl compound. For example, the compound may be a di- or tri-carboxylic (ester) amide, such as N,N′˜bis(2,2,6,6-tetramethyl-4-piperdiyl)-1,3-benzenedicarboxamide (Nylostab® S-EED).

One or more light stabilizers can generally be present in the composition in an amount greater than about 0.01% by weight, such as in an amount greater than about 0.05% by weight, such as in an amount greater than about 0.08% by weight, and generally in an amount less than about 2% by weight, such as in an amount less than about 1% by weight, such as in an amount less than about 0.8% by weight, such as in an amount less than about 0.5% by weight, such as in an amount less than about 0.3% by weight, such as in an amount less than about 0.2% by weight.

In one embodiment, the flame retardant polyamide polymer composition can also contain a lubricant. Any suitable lubricant can be incorporated into the polymer composition. In one aspect, the lubricant can comprise a partially saponified ester wax. For example, the lubricant can comprise a partially saponified ester wax of a C22 to C36 fatty acid. The fatty acid, for instance, can comprise a montan wax. In one aspect, the lubricant can contain 1-methyl-1,3-propanediyl esters. The lubricant can be present in the polymer composition generally in an amount greater than about 0.08% by weight, such as in an amount greater than about 0.1% by weight, such as in an amount greater than about 0.2% by weight, such as in an amount greater than about 0.3% by weight, such as in an amount greater than about 0.4% by weight, and generally in an amount less than about 2.5% by weight, such as in an amount less than about 2% by weight, such as in an amount less than about 1.5% by weight, such as in an amount less than about 1% by weight, such as in an amount less than about 0.8% by weight.

Another component that may be optionally contained in the polymer composition is metal oxide particles, such as silicon dioxide particles. The metal oxide particles or silicon dioxide particles can be present in relatively minor amounts. For instance, the particles can be present in the polymer composition in an amount greater than about 0.001% by weight, such as in an amount greater than about 0.005% by weight, such as in an amount greater than about 0.008% by weight, such as in an amount greater than about 0.01% by weight, such as in an amount greater than about 0.03% by weight. The particles are generally present in an amount less than about 1.5% by weight, such as in an amount less than about 1% by weight, such as in an amount less than about 0.8% by weight, such as in an amount less than about 0.5% by weight, such as in an amount less than about 0.3% by weight, such as in an amount less than about 0.2% by weight.

A wide variety of additional additives can also be included in the polyamide composition, such as impact modifiers, compatibilizers, particulate fillers (e.g., mineral fillers), pigments, and/or other materials added to enhance properties and processability.

The polyamide, inorganic fibers, flame retardant system, and other additives may be melt processed or blended together. The components may be supplied separately or in combination to an extruder that includes at least one screw rotatably mounted and received within a barrel (e.g., cylindrical barrel) and may define a feed section and a melting section located downstream from the feed section along the length of the screw. The fibers may optionally be added a location downstream from the point at which the polyamide is supplied (e.g., hopper). If desired, the flame retardant(s) may also be added to the extruder a location downstream from the point at which the polyamide is supplied. One or more of the sections of the extruder are typically heated, such as within a temperature range of from about 200° C. to about 450° C., in some embodiments, from about 220° C. to about 350° C., and in some embodiments, from about 250° C. to about 350° C. to form the composition. The speed of the screw may be selected to achieve the desired residence time, shear rate, melt processing temperature, etc. For example, the screw speed may range from about 50 to about 800 revolutions per minute (“rpm”), in some embodiments from about 70 to about 150 rpm, and in some embodiments, from about 80 to about 120 rpm. The apparent shear rate during melt blending may also range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. The apparent shear rate is equal to 4Q/πR³, where Q is the volumetric flow rate (“m³/s”) of the polymer melt and R is the radius (“m”) of the capillary (e.g., extruder die) through which the melted polymer flows.

Regardless of the particular manner in which it is formed, the resulting polyamide composition can possess excellent thermal properties. For example, the melt viscosity of the polyamide composition may be low enough so that it can readily flow into the cavity of a mold having small dimensions. In one particular embodiment, the polyamide composition may have a melt viscosity of from about 400 to about 1,000 Pascal-seconds (“Pa·s”), in some embodiments from about 450 to about 900 Pa·s, and in some embodiments, from about 500 to about 800 Pa·s, determined at a shear rate of 1000 seconds⁻¹. Melt viscosity may be determined in accordance with ISO Test No. 11443:2005 at a temperature that is 15° C. higher than the melting temperature of the composition (e.g., 285° C.).

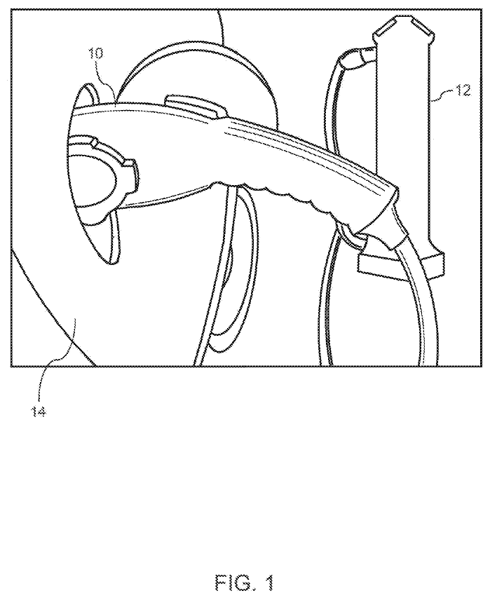

The flame retardant polyamide polymer composition of the present disclosure can be used to produce all different types of molded components and parts. Examples of articles that can incorporate the polymer composition are illustrated in FIGS. 1-9. Referring to FIG. 1, for instance, a high voltage charging plug or connector 10 is illustrated. As shown, the charging plug 10 is in electrical communication with a voltage source 12 and is connected to an electric vehicle 14. The charging plug or connector 10 can include a connector portion that includes an electrical pin that makes an electrical connection with a high voltage circuit contained within the electric vehicle 14. A protection or insulating member extends from a base and surrounds at least a portion of the electrical pin contained within the charging plug 10. At least the base of the protection member can be comprised of the flame retardant polymer composition of the present disclosure. The flame retardant polymer composition of the present disclosure can also be used to produce various other components contained within the charging plug 10.

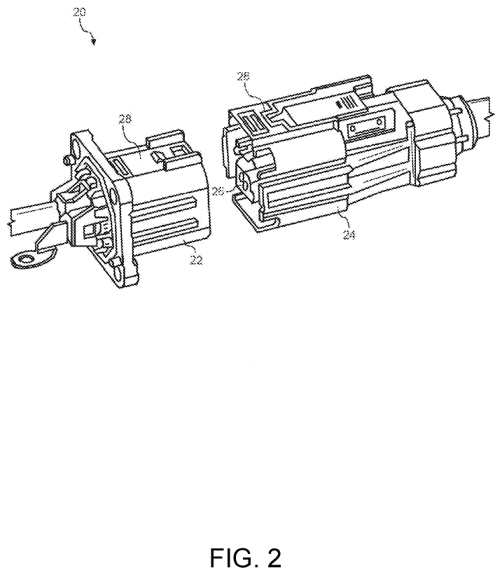

Referring to FIG. 2, a high voltage electrical connector generally 20 is shown. The connector 20 includes a first connector component 22 that is inserted into and interlocks with a second connector component 24. The electrical connector 20 can include an electrically conductive component 26 that is surrounded by a polymer component 28. The polymer component 28 can be made from the flame retardant polymer composition of the present disclosure. As shown in FIG. 2, the electrical connector 20 can have a complex shape with thin walls in certain areas. Due to the melt flow properties of the polymer composition of the present disclosure, the composition is well suited to forming the electrical connector 20 as shown in FIG. 2 through any suitable molding process, such as injection molding.

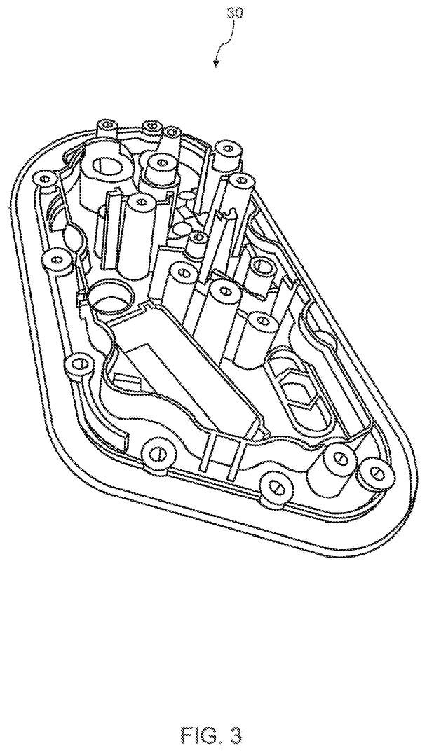

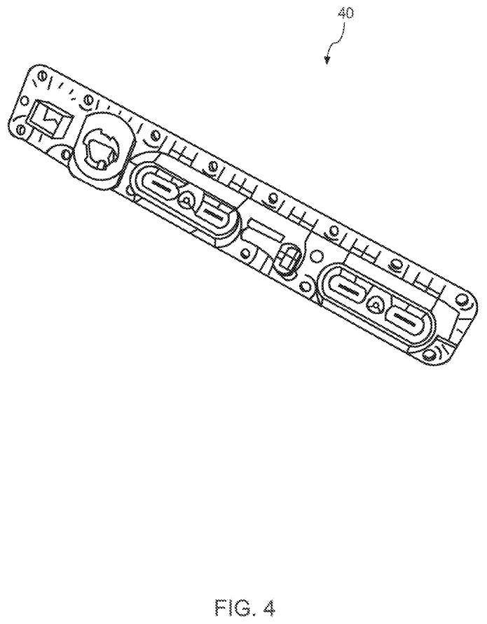

In one embodiment, the polymer composition of the present disclosure can also be used to produce housings that contain electrical components. For example, referring to FIG. 3, a portion of a battery housing 30 is shown. The battery housing 30 can include various different complex shapes that can all be molded from the flame retardant polymer composition of the present disclosure. Similarly, FIG. 4 illustrates a battery plug board 40 that can also be molded from the polymer composition of the present disclosure. The battery plug board 40 can, in one embodiment, form a portion of the housing of the battery and can be used to connect the battery to an electrical connector.

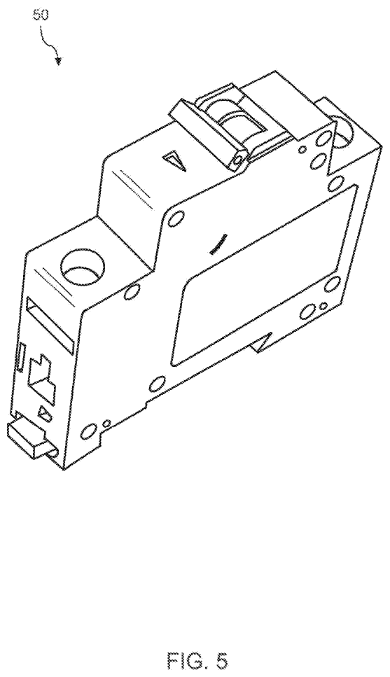

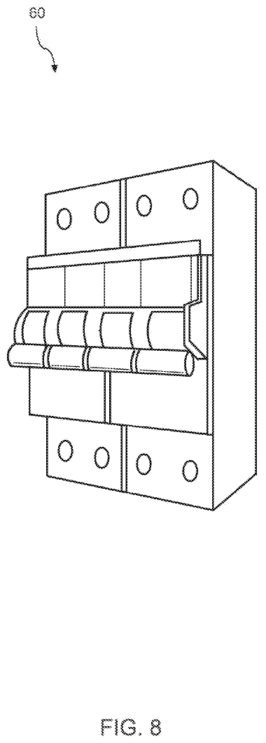

In another embodiment, the flame retardant polyamide polymer composition of the present disclosure can be used to construct circuit breakers. For example, a single switch circuit breaker 50 is shown in FIG. 5 while another embodiment of a circuit breaker 60 is shown in FIG. 8 containing multiple switches. The circuit breaker contains electrical components that are placed within a circuit at a residential household, an industrial facility, or the like. The flame retardant polyamide polymer composition of the present disclosure can be used to construct an insulating component within the circuit breaker 50 or 60, can construct the housing of the circuit breaker 50 or 60, or can also be used to form the switches on the circuit breaker 50 or 60.

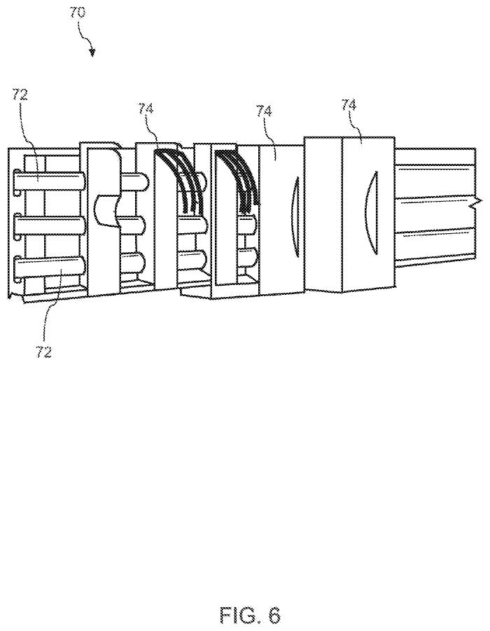

Referring to FIG. 6, a contact rail 70 is illustrated. The contact rail 70 includes conductive members 72. The contact rail 70 is configured to make direct contact with conducting power rails. As shown in FIG. 6, the contact rail 70 includes polymer components 74 that can be made from the flame retardant polymer composition of the present disclosure.

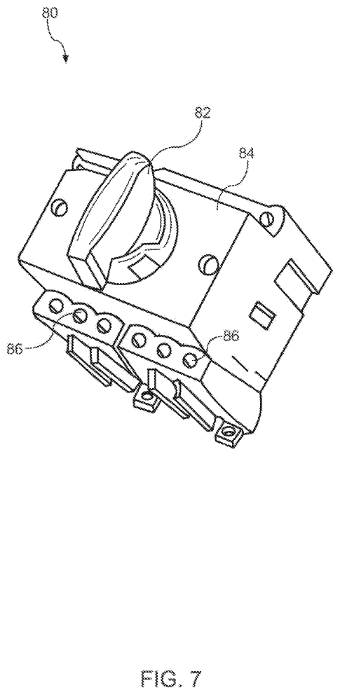

Referring to FIG. 7, an electrical switch 80 made in accordance with the present disclosure is shown. The electrical switch 80 includes a switch 82, a housing 84, and various different electrical components 86. The switch 82 and the housing 84 can be formed from the flame resistant polyamide polymer composition of the present disclosure.

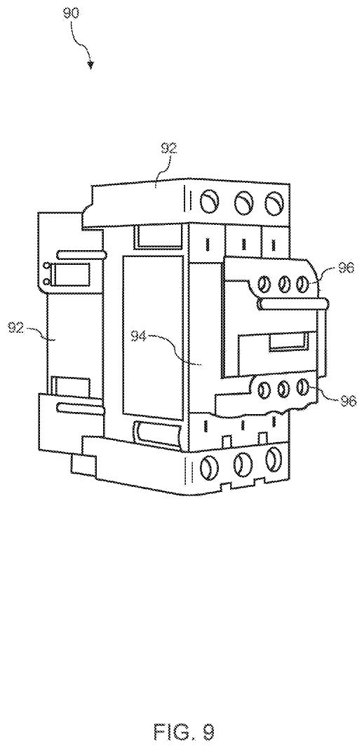

Referring to FIG. 9, another electrical component that can be constructed in accordance with the present disclosure is shown. More particularly, FIG. 9 illustrates an electrical contactor 90. The electrical contactor 90 includes a housing 92 that encloses a polymer component 94 that surrounds conductive components 96. The polymer or insulating component 94 and/or the housing 92 can be formed from the flame retardant polyamide polymer composition of the present disclosure.

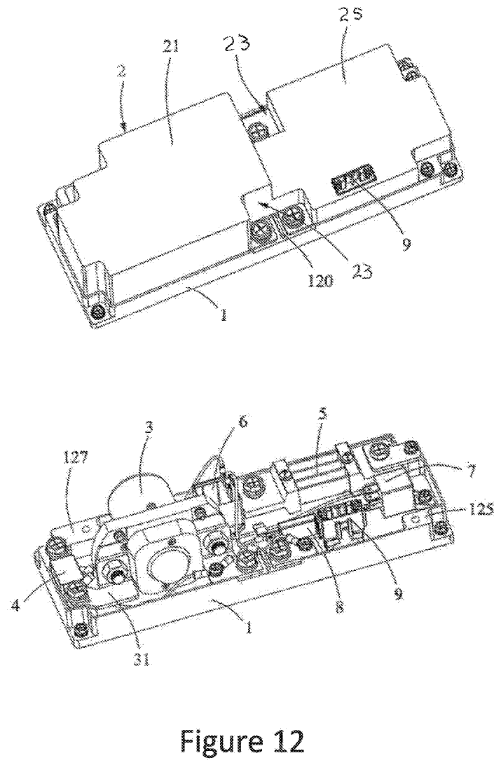

Apart from the structures shown in FIGS. 1 through 9, various other electric components, especially well suited for electric vehicles, may also employ the polymer composition of the present disclosure. In one embodiment, for example, a battery system of an electric vehicle may include a battery module (e.g., lithium ion battery module) that is electrically connected to a relay box. Typically, such boxes also include other electronic components, such as main relays, main fuses, shunts, heating relays, pre-charging relays, pre-charging resistors, etc. The polymer composition may be used to form one or more components of the battery module, relay box, or a combination thereof. In one embodiment, the relay box may contain a housing that includes the polymer composition. To realize charging and discharging of the battery module, the battery system may include a positive circuit, a negative circuit, a pre-charging circuit and a heating circuit composed of various electrical components. Referring to FIG. 12, for example, one embodiment of a battery system is shown that includes, for example, a main relay 3, main fuse 4, shunt 5, heating relay 6, pre-charging relay 7, and a pre-charging resistor 8. The system may also include a relay box that, in this particular embodiment, is formed from a housing that includes a base 1 and an upper cover 2. Of course, it should also be understood that the box may be an integral component, or may contain other portions. If desired, the base 1 and/or upper cover 2 may be made from the polymer composition of the present disclosure.

In the illustrated embodiment, the positive circuit includes the main relay 3 and the main fuse 4 connected in series. The main fuse 4 is electrically connected to the positive output terminal of the battery module (not shown). The upper cover 2 includes a first box cover 21 and a second box cover 25 that communicate with each other, the first box cover 21 covers a first area and the second box cover 25 covers a second area. The first box cover 21 and the second box cover 25 may be connected to form a stepped structure, so that the resulting box has a regular shape. The main fuse 4 may be connected in series with the main relay 3 through a connection row 31 to form a positive circuit, so that the input row of the positive circuit is fixedly supported on the first boss.

The outer side walls of the upper cover 2 have inwardly recessed grooves 23 at corner positions and the positions where the first box cover 21 and the second box cover 25 are connected. The grooves 23 in the upper left corner of the first box cover 21 give way to the input row of the positive circuit, and the grooves 23 in the upper left corner and the upper right corner of the second box cover 25 respectively give way to the input row and output row of the negative circuit. Further, the upper cover 2 and the base 1 are fixedly connected by bolts. Specifically, the diagonal positions of the accommodating groove have bosses 125 and bosses 127, and the diagonal positions of the upper cover 2 are recessed inward to form installation grooves. Preferably, a partition plate 120 is provided on the combination boss and located between the input row of the heating circuit and the output row of the positive circuit, so as to realize the physical insulation of the heating circuit and the positive circuit, and improve the reliability of the power distribution box. In addition, the box further includes an adapter plug 9. The positive circuit, the negative circuit, the heating circuit, and the pre-charging circuit are all connected to an external control unit through the adapter plug 9 for communication, which avoids the chaotic wiring inside the box and reduces the usage of the wiring harness.

As shown above, the flame retardant polymer composition of the present disclosure is particularly well suited for constructing electrical components, including electrical components that operate under high voltages. The polymer composition can be formulated so as to exhibit flame retardant properties that are particularly dramatic when considering that the flame retardant system only contains two components in one embodiment. Although unknown, it is believed that the amounts of the flame retardant components, their relative weight ratios, and possibly the presence of the stabilizer package all combine together to dramatically improve flame resistance while also unexpectedly displaying improved melt processing characteristics.

The flammability of the composition can be characterized in accordance with Underwriter's Laboratory Bulletin 94 entitled “Test for Flammability of Plastic Materials, UL 94.” Several ratings can be applied based on the time to extinguish (total flame time of a set of five specimens) and the ability of the composition to resist dripping. The test can be applied to various different specimens having different thicknesses. In the past, the thicknesses typically varied from about 0.8 mm to about 3.2 mm. In the present case, as will be shown in the examples that follow, tests were conducted on molded specimens having a thickness of only 0.4 mm. Due to the thinness of the samples, specimens were first molded and then milled to the 0.4 mm thickness. It was discovered that the polymer composition of the present disclosure can still display a VO rating even at a thickness of 0.4 mm.

| Vertical | |
|---|---|
| Ratings | Requirements |
| V-0 | Specimens must not burn with flaming combustion for more |
| | than 10 seconds after either test flame application. |
| | Total flaming combustion time must not exceed 50 seconds |
| | for each set of 5 specimens. |
| | Specimens must not burn with flaming or glowing combustion |
| | up to the specimen holding clamp. |
| | Specimens must not drip flaming particles that ignite the |
| | cotton. No specimen can have glowing combustion remain for |
| | longer than 30 seconds after removal of the test flame. |
| V-1 | Specimens must not burn with flaming combustion for more |
| | than 30 seconds after either test flame application. |
| | Total flaming combustion time must not exceed 250 seconds |
| | for each set of 5 specimens. |
| | Specimens must not burn with flaming or glowing combustion |
| | up to the specimen holding clamp. |
| | Specimens must not drip flaming particles that ignite the |
| | cotton. |
| | No specimen can have glowing combustion remain for longer |
| | than 60 seconds after removal of the test flame. |
| V-2 | Specimens must not burn with flaming combustion for more |
| | than 30 seconds after either test flame application. |
| | Total flaming combustion time must not exceed 250 seconds |
| | for each set of 5 specimens. |
| | Specimens must not burn with flaming or glowing combustion |
| | up to the specimen holding clamp. |
| | Specimens can drip flaming particles that ignite the cotton. |
| | No specimen can have glowing combustion remain for longer |
| | than 60 seconds after removal of the test flame. |

### Example No. 1

### Test Methods for Examples

Tensile Modulus, Tensile Stress, and Tensile Elongation at Break: Tensile properties may be tested according to ISO 527:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus and Flexural Stress: Flexural properties may be tested according to ISO Test No. 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO ISO 179-1:2010) (technically equivalent to ASTM D256-10, Method B). This test may be run using a Type 1 specimen size (length of 80 mm, width of 10 mm, and thickness of 4 mm). Specimens may be cut from the center of a multi-purpose bar using a single tooth milling machine. The testing temperature may be 23° C. For “notched” impact strength, this test may be run using a Type A notch (0.25 mm base radius) and Type 1 specimen size (length of 80 mm, width of 10 mm, and thickness of 4 mm).

Comparative Tracking Index (“CTI”): The comparative tracking index (CTI) may be determined in accordance with International Standard IEC 60112-2020 to provide a quantitative indication of the ability of a composition to perform as an electrical insulating material under wet and/or contaminated conditions. In determining the CTI rating of a composition, two electrodes are placed on a molded test specimen. A voltage differential is then established between the electrodes while a 0.1% aqueous ammonium chloride solution is dropped onto a test specimen. The maximum voltage at which five (5) specimens withstand the test period for 50 drops without failure is determined. The test voltages range from 100 to 600 V in 25 V increments. The numerical value of the voltage that causes failure with the application of fifty (50) drops of the electrolyte is the “comparative tracking index.” The value provides an indication of the relative track resistance of the material. According to UL746A, a nominal part thickness of 3 mm is considered representative of performance at other thicknesses.

UL94: A specimen is supported in a vertical position and a flame is applied to the bottom of the specimen. The flame is applied for ten (10) seconds and then removed until flaming stops, at which time the flame is reapplied for another ten (10) seconds and then removed. Two (2) sets of five (5) specimens are tested. The sample size is a length of 125 mm, width of 13 mm, and thickness of 0.8 mm or as specified. The two sets are conditioned before and after aging. For unaged testing, each thickness is tested after conditioning for 48 hours at 23° C. and 50% relative humidity. For aged testing, five (5) samples of each thickness are tested after conditioning for 7 days at 70° C.

Various different polyamide polymer compositions were formulated and tested for various different properties as shown below (“x” designates that the component is present in an amount to equal 100% by weight). After being molded and dried, the samples above were tested for flame retardancy, CTI and various mechanical properties. The results are below.

| | Sample | Sample | Sample | Sample | Sample |
|---|---|---|---|---|---|
| | No. 1 | No. 2 | No. 3 | No. 4 | No. 5 |
| Component | % | % | % | % | % |
| Polyamide 6,6 | x | | x | | x |
| Polyamide 6 | 20 | x | | x | 20 |
| DEPAL | 14.7 | 14.7 | 12 | 12 | |
| Melamine poly(zinc phosphate) | 7.3 | 7.3 | | | |
| Melamine poly(magnesium phosphate) | | | 6 | 6 | |
| DOPO | | | | | 22 |
| Glass fibers | 30 | 30 | 30 | 30 | 30 |
| N,N′-bis[3-propanamide] | | | | | 0.1 |
| Calcium stearate | | | | | 0.5 |
| Partially saponified ester wax of | 0.5 | 0.5 | 0.5 | 0.5 | |
| montanic acid | | | | | |
| N,N′-bis(2,2,6,6-tetramethyl-4- | 0.1 | 0.1 | 0.1 | 0.1 | |
| piperidyl)-1,3-benzendicarboxamide | | | | | |
| Reaction product of 2,4-di-tert- | 0.2 | 0.2 | 0.2 | 0.2 | |
| butylphenol, phosphorous trichloride, | | | | | |
| and 1,1′-biphenyl (diphosphonite) | | | | | |
| iodobis(triphenylphosphino) copper | 0.5 | 0.5 | 0.5 | 0.5 | |
| with brominated synergist | | | | | |
| Silicon dioxide particles | 0.05 | 0.05 | 0.05 | 0.05 | |
| UL94 V0@0, 4 mm | V0 | V0 | V0 | no rating | V2 |
| UL94 V0@0, 8 mm | V0 | V0 | V0 | no rating | V2 |
| UL94 V0@0, 1, 6 mm | V0 | V0 | V0 | V0 | V2 |

### Electrical Properties

| | | | | | |
|---|---|---|---|---|---|
| CTI (volts) | 600 | 600 | 550 | 500 | 450-500 |
| Charpy unnotched at 23 C. | 61.6 | 64.1 | 73 | 66.3 | 28.8 |
| [kJ/m2] | | | | | |
| Charpy notched at 23 C. | 8.1 | 9.5 | 8.6 | 8.8 | 5.3 |
| [kJ/m2] | | | | | |

### Thermal Stability/TGA

### Onset

| | | | |
|---|---|---|---|
| Processability/Hot runner | ++ | ++ | −− |
| general processing | lower Std | lower Std | |
| | process | process | |
| | deviations | deviations | |
| Processability/Hot runner | ++ | ++ | −− |
| flowability/molding | −200 bar | −200 bar | |
| pressure | less than | less than | |
| | standard | standard | |

As shown above, Sample Nos. 1 and 2 displayed unexpectedly better melt processing characteristics.

### Example No. 2

Sample Nos. 1 and 2 above were subjected to long term heat aging. In particular, the test specimens were heat aged at 200° C. for 1,500 hours. The following results were obtained.

| | |
|---|---|
| Sample No. 1 | Sample No. 2 |

| | Charpy | | Charpy | |
|---|---|---|---|---|
| Hours at | notched | % | notched | % |
| 200° C. | (kJ/m²) | retention | (kJ/m²) | retention |
| 0 | 9.9 | 100.0 | 9.5 | 100.0 |
| 250 | 7.1 | 71.7 | 6.6 | 71.0 |
| 500 | 6.4 | 64.6 | 5.9 | 63.4 |
| 1000 | 6.1 | 61.6 | 5 | 53.8 |
| 1500 | 4.6 | 46.5 | 4.4 | 47.3 |

| | |
|---|---|
| Sample No. 1 | Sample No. 2 |

| | Tensile | | Tensile | |
|---|---|---|---|---|
| Hours at | Strength | % | Strength | % |
| 200° C. | (MPa) | retention | (MPa) | retention |
| 0 | 118.8 | 100.0 | 140 | 100.0 |
| 250 | 91.8 | 77.3 | 91.5 | 79.2 |
| 500 | 89.4 | 75.3 | 89.7 | 77.7 |
| 1000 | 77.9 | 65.6 | 82.6 | 71.5 |
| 1500 | 53.9 | 45.4 | 71.9 | 62.3 |

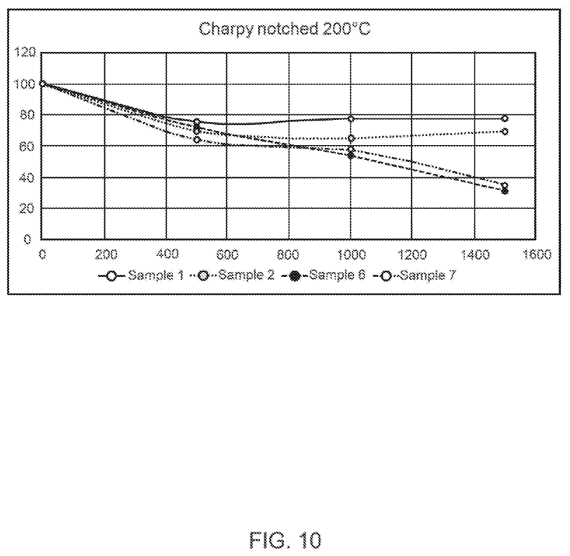

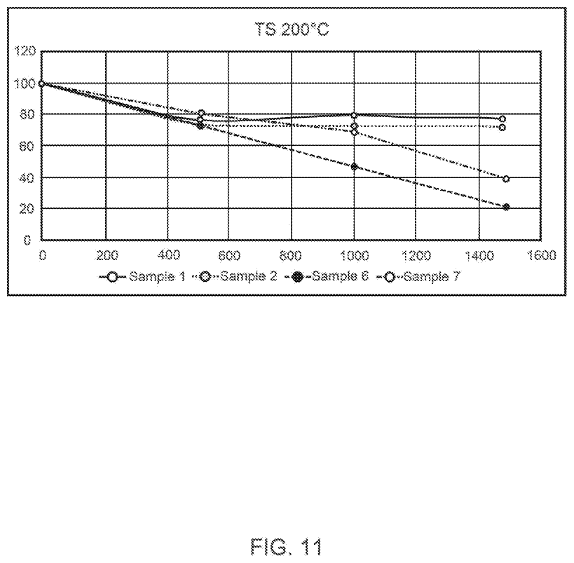

Sample Nos. 1 and 2 above were tested and compared with other formulations that contained conventional flame retardants. In particular, Sample Nos. 6 and 7 contained the same polyamide polymers but were combined with an EXOLIT flame retardant package obtained from Clariant. The results are illustrated in FIGS. 10 and 11. As shown in FIGS. 10 and 11, the polymer compositions made according to the present disclosure had dramatically better heat aging characteristics.

### Example No. 3

Various different flame retardant polyamide polymer compositions were formulated in accordance with the present disclosure. In this example, each of the compositions contained post-industrial recycled polyamide polymers in different amounts. The following results demonstrate that excellent properties can be obtained even when incorporating recycled polymers into the formulation.

The following formulations were tested and the following results were obtained.

| | Sample | Sample | Sample | Sample |
|---|---|---|---|---|
| | No. 8 | No. 9 | No. 10 | No. 11 |
| Polyamide 66 | 15.65% | 15.65% | 15.65% | |
| Polyamide 6 | 20.00% | 20.00% | 20.00% | 15.00% |
| Post-industrial recycled | | 15.00% | | |
| polyamide - 1 | | | | |
| Post-industrial recycled | 15.00% | | | |
| polyamide - 2 | | | | |
| Post-industrial recycled | | | 15.00% | |
| polyamide - 3 | | | | |
| Post-industrial recycled | | | | 35.65% |
| polyamide - 4 | | | | |
| Glass Fibers | 30.00% | 30.00% | 30.00% | 30.00% |
| Melamine poly(zinc | 6.00% | 6.00% | 6.00% | 6.00% |
| phosphate) | | | | |
| DEPAL | 12.00% | 12.00% | 12.00% | 12.00% |
| Partially saponified ester | 0.50% | 0.50% | 0.50% | 0.50% |
| wax if montanic acid | | | | |
| 1,3-benzendicarboxamide | 0.10% | 0.10% | 0.10% | 0.10% |
| Reaction product of 2,4- | 0.20% | 0.20% | 0.20% | 0.20% |
| di-tert-butylphenol, | | | | |
| phosphorous trichloride, | | | | |
| and 1,1′biphenyl | | | | |
| iodobis(triphenylphos- | 0.50% | 0.50% | 0.50% | 0.50% |
| phino) copper | | | | |
| Silicon dioxide particles | 0.05% | 0.05% | 0.05% | 0.05% |
| | 100.00% | 100.00% | 100.00% | 100.00% |
| Quantity kg | 75 | 75 | 75 | 75 |

### UL94

| | | | | |
|---|---|---|---|---|
| UL94A @ 0.4 mm | V0 | V0 | V0 | no rating |
| | | | | (clamp) |
| UL94A @ 0.8 mm | V0 | V0 | V0 | V0 |
| UL94A @ 1.6 mm | V0 | V0 | V0 | V0 |
| UL94A @ 3.2 mm | V0 | V0 | V0 | V0 |
| UL94B @ 0.4 mm | V0 | V0 | V0 | no rating |
| | | | | (clamp) |
| UL94B @ 0.8 mm | V0 | V0 | V0 | V0 |
| UL94B @ 1.6 mm | V0 | V0 | V0 | V0 |
| UL94B @ 3.2 mm | V0 | V0 | V0 | V0 |

### Tensile Test

| | | | | |
|---|---|---|---|---|
| E-Modulus [MPa] DAM | 9,940 | 10,389 | 10,200 | 10,279 |
| tensile strength [MPa] | 124.5 | 137.4 | 121.7 | 117.8 |
| DAM | | | | |
| elongation @ break [%] | 2.6 | 2.9 | 2.4 | 2.5 |
| DAM | | | | |

Cond. Iso 1110

| | | | | |
|---|---|---|---|---|
| E-Modulus [MPa] ISO 1110 | 5,711 | 5,832 | 5,717 | 5,817 |
| tensile strength [MPa] ISO 1110 | 77.8 | 81.7 | 72.5 | 74.2 |
| elongation @ break [%] ISO 1110 | 5.7 | 6.4 | 5.7 | 6.2 |

### LTHA @ 140° C.

| | | | | |
|---|---|---|---|---|
| E-Modulus [MPa] DAM | 9,940 | 10,389 | 10,200 | 10,280 |
| tensile strength [MPa] | 124.5 | 137.4 | 121.7 | 117.8 |
| DAM | | | | |
| elongation @ break [%] | 2.6 | 2.9 | 2.4 | 2.5 |
| DAM | | | | |
| E-Modulus [MPa] 500 h | 9,634 | 10,479 | 10,109 | 10,470 |
| Tensile strength [MPa] | 112.7 | 134.6 | 113.4 | 116.6 |
| 500 h | | | | |
| Elongation @ break [%] | 1.9 | 2.6 | 1.9 | 1.9 |
| 500 h | | | | |
| E-Modulus [MPa] 1000 h | 9,496 | 10,317 | 10,004 | 10,281 |
| Tensile strength [MPa] | 94.9 | 111.1 | 93.2 | 97.0 |
| 1000 h | | | | |
| Elongation @ break [%] | 1.3 | 1.6 | 1.3 | 1.3 |
| 1000 h | | | | |
| E-Modulus [MPa] 1500 h | 9,677 | 10,281 | 10,125 | 10,447 |
| tensile strength [MPa] | 91.5 | 101.4 | 90.7 | 93.2 |
| 1500 h | | | | |
| elongation @ break [%] | 1.3 | 1.4 | 1.2 | 1.2 |
| 1500 h | | | | |

### LTHA @ 200° C.

| | | | | |
|---|---|---|---|---|
| E-Modulus [MPa] DAM | 9,940 | 10,389 | 10,200 | 10,280 |
| tensile strength [MPa] | 124.5 | 137.4 | 121.7 | 117.8 |
| DAM | | | | |
| elongation @ break [%] | 2.6 | 2.9 | 2.4 | 2.5 |
| DAM | | | | |
| E-Modulus [MPa] 500 h | 9,880 | 11,119 | 10,923 | 11,375 |
| Tensile strength [MPa] | 94.6 | 102.4 | 95.1 | 89.8 |
| 500 h | | | | |
| Elongation @ break [%] | 1.3 | 1.3 | 1.2 | 1.0 |
| 500 h | | | | |
| E-Modulus [MPa] 1000 h | 9,425 | 10,678 | 10,268 | 11,194 |
| Tensile strength [MPa] | 93.4 | 100.3 | 94.8 | 82.9 |
| 1000 h | | | | |
| Elongation @ break [%] | 1.4 | 1.3 | 1.3 | 0.9 |
| 10000 h | | | | |
| E-Modulus [MPa] 1500 h | 9,281 | 10,360 | 10,044 | 11,224 |
| tensile strength [MPa] | 89.3 | 99.5 | 93.1 | 92.3 |
| 1500 h | | | | |
| elongation @ break [%] | 1.4 | 1.4 | 1.3 | 0.9 |
| 1500 h | | | | |

### CTI

| | | | | |
|---|---|---|---|---|
| CTI 100 [V] | 600 | 550 | 550 | 600 |

### MVR

| | | | | |
|---|---|---|---|---|
| MVR 275° C./5 kg | 111.1 | 56.2 | 64.5 | 167.9 |
| [cm3/10 min] | | | | |
| moisture content [%] | 0.08 | 0.05 | 0.08 | 0.08 |

### TGA

| | | | | |
|---|---|---|---|---|
| TGA onset [° C.] | 314.4 | 334.9 | 336.6 | 345.8 |
| TGA offset [° C.] | 454.2 | 482.5 | 482.6 | 470.7 |
| residual mass [%] | 36.18 | 35.88 | 36.54 | 33.81 |

### DSC

| | | | | |
|---|---|---|---|---|
| TM1 [° C.] | 258.8 | 260.5 | 258.7 | 223.3 |
| TM2 [° C.] | 245.5 | 246.4 | 244.7 | 220.7 |
| TM3 [° C.] | 238.1 | 238.9 | 237.1 | 220.5 |

### Vicat

| | | | | |
|---|---|---|---|---|
| Vicat 120 K/h; 10N | 234.5 | 238.8 | 238.6 | 213.7 |
| [° C.] | | | | |

### VN

| | | | | |
|---|---|---|---|---|
| viscosity number | 156.3 | 156.8 | 151.4 | 139.9 |
| [ml/g] | | | | |

### Example No. 4

Further flame retardant polyamide polymer compositions were formulated in accordance with the present disclosure.

Four (4) different polymer composition samples were formed from nylon 6, nylon 6,6, glass fibers, flame retardant system, stabilizer system, lubricant, and silica. The flame retardant system includes DEPAL (aluminum phosphinate) and melamine poly(zinc phosphate). The concentration of the components for each of the samples is listed in the table below.

| | Sample | Sample | Sample | Sample |
|---|---|---|---|---|
| | 12 | 13 | 14 | 15 |
| | (wt. %) | (wt. %) | (wt. %) | (wt. %) |
| polyamide 6,6 | 35.65 | 30.65 | — | — |
| polyamide 6 | 20.00 | 20.00 | 55.65 | 50.65 |
| Glass Fibers | 25 | 30 | 25 | 30 |
| DEPAL | 12 | 12 | 12 | 12 |
| Melamine Poly(Zinc Phosphate) | 6 | 6 | 6 | 6 |
| N,N′-bis(2,2,6,6-tetramethyl-4- | 0.1 | 0.1 | 0.1 | 0.1 |
| piperidyl)-1,3-benzendicarbox- | | | | |
| amide | | | | |
| (tetrakis(2,4-di-tert-butylphen- | 0.2 | 0.2 | 0.2 | 0.2 |
| yl)4,4′-biphenylene-diphosphonite) | | | | |
| iodobis(triphenylphosphino) copper | 0.5 | 0.5 | 0.5 | 0.5 |
| and a brominated synergist | | | | |
| Partially saponified ester wax of | 0.5 | 0.5 | 0.5 | 0.5 |
| montanic acid | | | | |
| Silica | 0.05 | 0.05 | 0.05 | 0.05 |

After being molded and dried, Sample Nos. 12 through 15 were tested for various mechanical properties. The results are set forth in the table below.

| | Sample | Sample | Sample | Sample |
|---|---|---|---|---|
| | 12 | 13 | 14 | 15 |
| Tensile Modulus (MPa) | 8,983 | 10,389 | 9,220 | 10,659 |
| Tensile Strength (MPa) | 122 | 131 | 131 | 140 |
| Elongation at Break (%) | 3.0 | 2.9 | 3.0 | 3.1 |
| Unnotched Charpy at 23° C. | 55.2 | 55.5 | 58.9 | 64.1 |
| (kJ/m²) | | | | |
| Notched Charpy at 23° C. | 7.1 | 7.6 | 8.1 | 9.5 |
| (kJ/m²) | | | | |

Sample Nos. 12 through 15 were also subjected to long term heat aging after being molded and dried. In particular, the test specimens were heat aged at 140° C. and 200° C. for 3,000 hours. The results are set forth in the tables below.

| | |
|---|---|
| Sample 12 | Sample 13 |

| | Charpy | Ratio of | Charpy | Ratio of |
|---|---|---|---|---|
| Hours at | notched | Aged to | notched | Aged to |
| 140° C. | (kJ/m²) | Initial | (kJ/m²) | Initial |
| 0 | 7.1 | — | 7.6 | — |
| 500 | 6.4 | 0.9 | 7.4 | 1.0 |
| 1000 | 6.3 | 0.9 | 7.0 | 0.9 |
| 3000 | 5.8 | 0.8 | 4.0 | 0.5 |

| | |
|---|---|
| Sample 14 | Sample 15 |

| | Charpy | Ratio of | Charpy | Ratio of |
|---|---|---|---|---|
| Hours at | notched | Aged to | notched | Aged to |
| 140° C. | (kJ/m²) | Initial | (kJ/m²) | Initial |
| 0 | 8.1 | — | 9.5 | — |
| 500 | 7.5 | 0.9 | 8.2 | 0.9 |
| 1000 | 6.9 | 0.9 | 7.9 | 0.8 |
| 3000 | 6.9 | 0.9 | 7.1 | 0.7 |

| | |
|---|---|
| Sample 12 | Sample 13 |

| | Tensile | Ratio | Tensile | Ratio |
|---|---|---|---|---|
| Hours at | Modulus | of Aged | Modulus | of Aged |
| 140° C. | (MPa) | to Initial | (MPa) | to Initial |
| 0 | 8,983 | — | 10,389 | — |
| 500 | 8,619 | 1.0 | 9,949 | 1.0 |
| 1000 | 8,784 | 1.0 | 10,221 | 1.0 |
| 3000 | 8,669 | 1.0 | 9,728 | 0.9 |

| | |
|---|---|
| Sample 14 | Sample 15 |

| | Tensile | Ratio | Tensile | Ratio |
|---|---|---|---|---|
| Hours at | Modulus | of Aged | Modulus | of Aged |
| 140° C. | (MPa) | to Initial | (MPa) | to Initial |
| 0 | 9,220 | — | 10,659 | — |
| 500 | 9,072 | 1.0 | 10,630 | 1.0 |
| 1000 | 9,136 | 1.0 | 10,641 | 1.0 |
| 3000 | 9,074 | 1.0 | 10,540 | 1.0 |

| | |
|---|---|
| Sample 12 | Sample 13 |

| | Tensile | Ratio | Tensile | Ratio |
|---|---|---|---|---|
| Hours at | Strength | of Aged | Strength | of Aged |
| 140° C. | (MPa) | to Initial | (MPa) | to Initial |
| 0 | 122 | — | 131 | — |
| 500 | 109 | 0.9 | 114 | 0.9 |
| 1000 | 98 | 0.8 | 106 | 0.8 |
| 3000 | 89 | 0.7 | 94 | 0.7 |

| | |
|---|---|
| Sample 14 | Sample 15 |

| | Tensile | Ratio | Tensile | Ratio |
|---|---|---|---|---|
| Hours at | Strength | of Aged | Strength | of Aged |
| 140° C. | (MPa) | to Initial | (MPa) | to Initial |
| 0 | 131 | — | 140 | — |
| 500 | 117 | 0.9 | 124 | 0.9 |
| 1000 | 108 | 0.8 | 112 | 0.8 |
| 3000 | 99 | 0.8 | 100 | 0.7 |

| | |
|---|---|
| Sample 12 | Sample 13 |

| Hours at | Tensile | Ratio | Tensile | Ratio |
|---|---|---|---|---|
| 140° C. | Elongation | of Aged | Elongation | of Aged |
| | (%) | to Initial | (%) | to Initial |
| 0 | 3.0 | — | 2.9 | — |
| 500 | 2.0 | 0.7 | 1.9 | 0.7 |
| 1000 | 1.7 | 0.6 | 1.5 | 0.5 |
| 3000 | 1.4 | 0.5 | 1.3 | 0.4 |

| | |
|---|---|
| Sample 14 | Sample 15 |

| | Tensile | Ratio | Tensile | Ratio |
|---|---|---|---|---|
| Hours at | Elongation | of Aged | Elongation | of Aged |
| 140° C. | (%) | to Initial | (%) | to Initial |
| 0 | 3.0 | — | 3.1 | — |
| 500 | 2.1 | 0.7 | 1.9 | 0.6 |
| 1000 | 1.8 | 0.6 | 1.6 | 0.5 |
| 3000 | 1.6 | 0.5 | 1.3 | 0.4 |

| | |
|---|---|
| Sample 12 | Sample 13 |

| | Charpy | Ratio | Charpy | Ratio |
|---|---|---|---|---|
| Hours at | notched | of Aged | notched | of Aged |
| 200° C. | (kJ/m²) | to Initial | (kJ/m²) | to Initial |
| 0 | 7.1 | — | 7.6 | — |
| 500 | 5.0 | 0.7 | 5.7 | 0.8 |
| 1000 | 5.0 | 0.7 | 5.9 | 0.8 |
| 3000 | 5.3 | 0.7 | 5.6 | 0.7 |

| | |
|---|---|
| Sample 14 | Sample 15 |

| | Charpy | Ratio | Charpy | Ratio |
|---|---|---|---|---|
| Hours at | notched | of Aged | notched | of Aged |
| 200° C. | (kJ/m²) | to Initial | (kJ/m²) | to Initial |
| 0 | 8.1 | — | 9.5 | — |
| 500 | 5.9 | 0.7 | 6.6 | 0.7 |
| 1000 | 5.9 | 0.7 | 6.2 | 0.7 |
| 3000 | 6.2 | 0.8 | 8.0 | 0.8 |

| | |
|---|---|
| Sample 12 | Sample 13 |

| | Tensile | Ratio | Tensile | Ratio |
|---|---|---|---|---|
| Hours at | Modulus | of Aged | Modulus | of Aged |
| 200° C. | (MPa) | to Initial | (MPa) | to Initial |
| 0 | 8,983 | — | 10,389 | — |
| 500 | 8,838 | 1.0 | 9,994 | 1.0 |
| 1000 | 8,798 | 1.0 | 9,960 | 1.0 |
| 3000 | 8,194 | 0.9 | 8,765 | 0.8 |

| | |
|---|---|
| Sample 14 | Sample 15 |

| | Tensile | Ratio | Tensile | Ratio |
|---|---|---|---|---|
| Hours at | Modulus | of Aged | Modulus | of Aged |
| 200° C. | (MPa) | to Initial | (MPa) | to Initial |
| 0 | 9,220 | — | 10,659 | — |
| 500 | 9,494 | 1.0 | 11,052 | 1.0 |
| 1000 | 9,492 | 1.0 | 11,159 | 1.0 |
| 3000 | 9,137 | 1.0 | 10,819 | 1.0 |

| | |
|---|---|
| Sample 12 | Sample 13 |

| | Tensile | Ratio | Tensile | Ratio |
|---|---|---|---|---|
| Hours at | Strength | of Aged | Strength | of Aged |
| 200° C. | (MPa) | to Initial | (MPa) | to Initial |
| 0 | 122 | — | 131 | — |
| 500 | 95 | 0.8 | 100 | 0.8 |
| 1000 | 91 | 0.7 | 103 | 0.8 |
| 3000 | 51 | 0.4 | 97 | 0.7 |

| | |
|---|---|
| Sample 14 | Sample 15 |

| | Tensile | Ratio | Tensile | Ratio |
|---|---|---|---|---|
| Hours at | Strength | of Aged | Strength | of Aged |
| 200° C. | (MPa) | to Initial | (MPa) | to Initial |
| 0 | 131 | — | 140 | — |
| 500 | 99 | 0.8 | 101 | 0.7 |
| 1000 | 93 | 0.7 | 97 | 0.7 |
| 3000 | 53 | 0.4 | 76 | 0.5 |

| | |
|---|---|
| Sample 12 | Sample 13 |

| | Tensile | Ratio | Tensile | Ratio |
|---|---|---|---|---|
| Hours at | Elongation | of Aged | Elongation | of Aged |
| 200° C. | (%) | to Initial | (%) | to Initial |
| 0 | 3.0 | — | 2.9 | — |
| 500 | 1.5 | 0.5 | 1.4 | 0.5 |
| 1000 | 1.5 | 0.5 | 1.5 | 0.5 |
| 3000 | 0.7 | 0.2 | 1.7 | 0.6 |

| | |
|---|---|
| Sample 14 | Sample 15 |

| | Tensile | Ratio | Tensile | Ratio |
|---|---|---|---|---|
| Hours at | Elongation | of Aged | Elongation | of Aged |
| 200° C. | (%) | to Initial | (%) | to Initial |
| 0 | 3.0 | — | 3.1 | — |
| 500 | 1.4 | 0.5 | 1.2 | 0.4 |
| 1000 | 1.3 | 0.4 | 1.2 | 0.4 |
| 3000 | 0.6 | 0.2 | 0.7 | 0.2 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed is:

1. A flame retardant polymer composition comprising a polyamide polymer, a plurality of inorganic fibers, and a flame retardant system comprising a metal phosphinate and a synergist comprising a melamine metal phosphate or a melamine poly(metal phosphate), the flame retardant system being present in the polymer composition in an amount greater than 18.5 percent by weight and wherein, at a thickness of 0.4 millimeters, the composition exhibits a VO rating as determined in accordance with UL94 and displays a comparative tracking index of 600 volts or more as determined in accordance with IEC 60112:2020.

2. The flame retardant polymer composition of claim 1, wherein the synergist comprises melamine poly(zinc phosphate).

3. The flame retardant polymer composition of claim 1, wherein the synergist is present in the polymer composition in an amount of from about 4 wt. % to about 9 wt. %.

4. The flame retardant polymer composition of claim 1, further comprising a stabilizer package comprising an antioxidant, a heat stabilizer, and optionally a light stabilizer, the heat stabilizer comprising a copper compound.

5. The flame retardant polymer composition of claim 4, wherein the copper compound includes a copper(I) salt, copper(II) salt, copper complex, or a combination thereof.

6. The flame retardant polymer composition of claim 4, wherein the heat stabilizer further includes a halogen-containing synergist.

7. The flame retardant polymer composition of claim 4, wherein the heat stabilizer comprises iodobis(triphenylphosphino) copper.

8. The flame retardant polymer composition of claim 4, wherein the antioxidant comprises a reaction product of 2,4-di-tert-butylphenol, phosphorous trichloride, and 1,1′-biphenyl.

9. The flame retardant polymer composition of claim 4, wherein the antioxidant comprises a phosphonite having the structure:
[R—P(OR₁)₂]ₘ (1)
wherein,
R is a mono- or polyvalent aliphatic, aromatic, or heteroaromatic organic radical; and
R₁ is independently a compound of the structure (II) 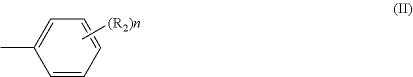
or the two radicals R₁ form a bridging group of the structure (III) 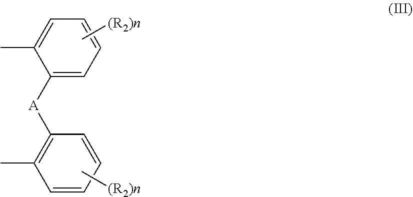
where
A is a direct bond, O, S, C₁₋₁₈ alkylene (linear or branched), or C₁₋₁₈ alkylidene (linear or branched);
R₂ is independently C₁₋₁₂ alkyl (linear or branched), C₁₋₁₂ alkoxy, or C₅₋₁₂ cycloalkyl;
n is from 0 to 5, and
m is from 1 to 4.

10. The flame retardant polymer composition of claim 9, wherein R is a cyclohexyl, phenyl, phenylene, or biphenyl radical, and R₁ a group of the structure (II) and wherein m is 2 and n is from 2 to 3.

11. The flame retardant polymer composition of claim 1, further comprising silicon dioxide particles present in an amount from about 0.001 wt. % to about 1.5 wt. %.

12. The flame retardant polymer composition of claim 1, further comprising a lubricant.

13. The flame retardant polymer composition of claim 12, wherein the lubricant comprises a partially saponified ester wax of a C₂₂ to C₃₆ fatty acid.

14. The flame retardant polymer composition of claim 1, wherein polyamides constitute from about 30 wt. % to about 70 wt. % of the composition, inorganic fibers constitute from about 5 wt. % to about 50 wt. % of the composition, and the flame retardant system constitutes from about 19 wt. % to about 27 wt. % of the composition.

15. The flame retardant polymer composition of claim 1, wherein the metal phosphinate has the general formula (I) and/or formula (II): 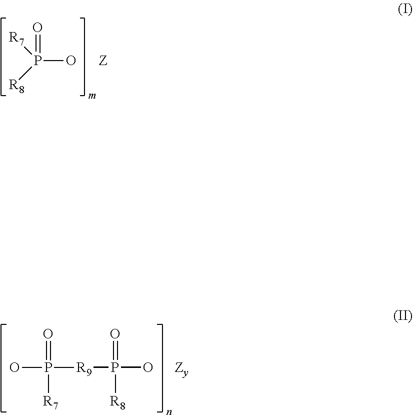
wherein,
R₇ and R₈ are, independently, hydrogen or substituted or unsubstituted, straight chain, branched, or cyclic hydrocarbon groups having 1 to 6 carbon atoms;
R₉ is a substituted or unsubstituted, straight chain, branched, or cyclic C₁-C₁₀ alkylene, arylene, arylalkylene, or alkylarylene group;
Z is Mg, Ca, Al, Sb, Sn, Ge, Ti, Zn, Fe, Zr, Ce, Bi, Sr, Mn, Li, Na, K, and/or a protonated nitrogen base;
y is from 1 to 4;
n is from 1 to 4; and
m is from 1 to 4.

16. The flame retardant polymer composition of claim 1, wherein the phosphinate is a metal salt of dimethylphosphinic acid, ethylmethylphosphinic acid, diethylphosphinic acid, methyl-n-propylphosphinic acid, methane-di(methylphosphinic acid), ethane-1,2-di(methylphosphinic acid), hexane-1,6-di(methylphosphinic acid), benzene-1,4-di(methylphosphinic acid), methylphenylphosphinic acid, diphenylphosphinic acid, hypophosphoric acid, or a mixture thereof.

17. The flame retardant polymer composition of claim 1, wherein the flame retardant system is free of zinc borate.

18. The flame retardant polymer composition of claim 1, wherein the polyamide is an aliphatic polyamide, and wherein the aliphatic polyamide is nylon-6, nylon-6,6, a copolymer thereof, or a combination thereof.

19. The flame retardant polymer composition of claim 18, wherein the aliphatic polyamide is present with a semi-aromatic polyamide or a wholly aromatic polyamide.

20. The flame retardant polymer composition of claim 1, wherein the inorganic fibers include glass fibers and are present in the polymer composition in an amount of from about 25 wt. % to about 35 wt. %, the glass fibers having an average fiber length of from about 150 microns to about 600 microns.a

21. A flame retardant polymer composition comprising a polyamide polymer, a plurality of inorganic fibers, and a flame retardant system comprising a metal phosphinate and a synergist comprising a melamine metal phosphate or a melamine poly(metal phosphate), the polymer composition further comprising a stabilizer package comprising an antioxidant, a heat stabilizer, and optionally a light stabilizer, the heat stabilizer comprising a copper complex and wherein the composition exhibits a comparative tracking index of 600 volts or more as determined in accordance with IEC 60112:2020.

22. The flame retardant polymer composition of claim 21, wherein the synergist comprises melamine poly(zinc phosphate).

23. The flame retardant polymer composition of claim 21, wherein the synergist is present in the polymer composition in an amount of from about 4 wt. % to about 9 wt. %, and the metal phosphinate is present in the polymer composition in an amount of from about 12.5 wt. % to about 16 wt. %.

24. A flame retardant polymer composition comprising a polyamide polymer, a plurality of inorganic fibers, and a flame retardant system comprising a metal phosphinate and a synergist comprising a melamine metal phosphate or a melamine poly(metal phosphate), the polymer composition further comprising a stabilizer package comprising an antioxidant, a heat stabilizer, and optionally a light stabilizer, and wherein the composition, after being heat aged at 200 C for 1500 hours, exhibits a drop in notched Charpy impact strength resistance and a drop in tensile strength of less than about 50%.

25. An electrical connector that comprises opposing walls between which a passageway is defined for receiving a contact pin, wherein at least one of the walls contains the flame retardant polymer composition as defined in claim 1.

26. An electrical device comprising an electrically conductive component surrounded by a molded polymer component, the polymer component comprising the flame retardant polymer composition as defined in claim 1, the electrical device comprising an electrical switch, an electrical contactor, a circuit breaker, a contact rail, a battery, a battery plug board, or a switchgear.

27. A battery system for an electric vehicle comprising a battery module and a relay box, wherein the relay box comprises the flame retardant polymer composition as defined in claim 1.
